(19) United States
(12) Patent Application Publication
(10) Pub. No.: US 2020/0126557 A1
(43) Pub. Date: Apr. 23, 2020

(54) SPEECH INTENTION EXPRESSION SYSTEM USING PHYSICAL CHARACTERISTICS OF HEAD AND NECK ARTICULATOR

(71) Applicant: Inha University Research and Business Foundation, Incheon (KR)

(72) Inventors: Woo Key LEE, Gunpo-si (KR); Bong Sup SHIM, Incheon (KR); Heon Do KWON, Andong-si (KR); Deok Hwan KIM, Seoul (KR); Jin Ho SHIN, Incheon (KR)

(73) Assignee: Inha University Research and Business Foundation, Incheon (KR)

(21) Appl. No.: 16/605,361

(22) PCT Filed: Apr. 13, 2018
(86) PCT No.: PCT/KR2018/004325

§ 371 Date: Oct. 15, 2019

(30) Foreign Application Priority Data
Apr. 13, 2017 (KR) 10-2017-0048010
Sep. 28, 2017 (KR) 10-2017-0125765
Sep. 28, 2017 (KR) 10-2017-0126048
Sep. 28, 2017 (KR) 10-2017-0126049
Sep. 28, 2017 (KR) 10-2017-0126469
Sep. 28, 2017 (KR) 10-2017-0126470
Sep. 29, 2017 (KR) 10-2017-0126769
Sep. 29, 2017 (KR) 10-2017-0126770

(51) Int. Cl. G10L 15/25; G10L 21/06; G10L 15/22; G06F 3/01

(52) U.S. Cl. CPC G10L 15/25; G10L 21/06; G10L 2015/227; G06F 3/011; G10L 15/22

(57) ABSTRACT

The present invention provides a speech intention expression system including a sensor part which is adjacent to one surface of the head and neck of a speaker and measures physical characteristics of articulators, a data interpretation part which grasps articulatory features of the speaker on the basis of the position of the sensor part and the physical characteristics of the articulators, a data conversion part which converts the position of the sensor part and the articulatory features to speech data, and a data expression part which expresses the speech data to the outside, wherein the sensor part includes an oral tongue sensor corresponding to the oral tongue.

### TECHNICAL FIELD

The present invention relates to a system in which physical characteristics of head and neck articulators including the oral tongue are recognized using an articulation sensor, changes throughout the head and neck due to speech are measured, and, in this way, an intention of the speech is grasped, thereby providing the intention of the speech to the speaker himself/herself or to the outside in visual, aural, and tactile manners and expressing the intention of the speech by transitioning the intention of the speech to head and neck of an image or a robot.

### BACKGROUND ART

A sound produced by articulators is referred to as a speech sound when the sound is for communication, which is linguistic transfer of information, and is referred to as phonation when the sound is non-linguistic.

Major organs of the human body that are involved in the production of sounds are the nervous system and the respiratory system.

In the nervous system, the central nervous system and the peripheral nervous system involve in the production of sounds. In the central nervous system, cranial nerve nuclei which are required for the production of sounds are located in the brainstem, the cerebellum has a function of precisely coordinating the control of muscles for movement, and the cerebral hemisphere plays a dominant role in speech mechanisms. The cranial nerves involved in the production of speech sounds include the fifth cranial nerve involved in the movement of jaws, the seventh cranial nerve involved in the movement of lips, the tenth cranial nerve involved in the movement of pharynx and larynx, the eleventh cranial nerve involved in the movement of pharynx, and the twelfth cranial nerve involved in the movement of tongue. In the peripheral nervous system, particularly, the superior laryngeal nerve and the recurrent laryngeal nerve which branch from the vagus nerve are directly involved in the movement of larynx.

Also, speech sounds are produced by close interaction between the lower respiratory system, the larynx, and the vocal tract. The vocal cords are the source of sounds. The flow of expired air transferred from the lung causes the vocal cords to vibrate, and the control of the expired air during phonation allows proper and active supply of sound energy. When the vocal cords are properly strained and closed, the vocal cords vibrate due to the expired air, and the flow of the expired air passing through the glottis is regulated by opening and closing the glottis at predetermined intervals. The interrupted flow of the expired air is the source of sounds.

In order for a person to use words for communication, the person should go through various physiological processes. The articulation process refers to a process of producing phonemes, which are units of speech sounds, after phonated sounds are amplified and complemented through a resonance process.

The tongue is considered as the most important articulator. However, in fact, producing phonemes involves not only the tongue but also various structures of the oral cavity and face. The articulators include movable articulators such as the tongue, lips, soft palate, and jaws and immovable articulators such as the teeth and hard palate. The articulators block or restrict the airstream to produce consonants and vowels.

As the first articulator, the tongue has parts which are not easy to distinguish due to absence of distinct boundaries between the parts. However, in the functional aspect, distinguishing the external structure of the tongue helps to understand pathological articulation as well as normal articulation. The tongue can be divided into the apex (tip), the blade, the dorsum, the body, and the root, in order from the front. The tip of the tongue is the part used when we stick out the tongue or articulate the / [symbol] (r or l)/ when it is an initial sound in a syllable (for example: “ [symbol] (la-la-la)”). The blade is the part of the tongue mostly used when articulating phonemes produced from the front of the mouth, such as alveolars. The dorsum is the part of the tongue mostly used when articulating dorsal phonemes such as soft palate sounds (velar sounds).

As the second articulator, the lips form the opening of the mouth and play an important role in making facial expressions or articulating using the head and neck. Particularly, phonemes of various vowels are distinguished not only by the movement of the tongue but also by the shape of the lips. Bilabial consonants can only be pronounced when the lips are closed. The shape of the lips is deformed by the muscles surrounding the lips. For example, the orbicularis oris muscle surrounding the lips allows the lips to be closed or pursed and plays an important role in pronouncing bilabial consonants or rounded vowels such as / [symbol] (u)/. The quadratus labii superior muscle and the quadratus labii inferior muscle allow the lips to be open. Also, the risorius muscle plays an important role when making a smile by pulling up the corners of the lips or when producing sounds, such as / [symbol] (i)/, which have to be pronounced by contracting the lips.

As the third articulator, in the jaws and teeth, the jaws are divided into the upper jaw (maxilla) which is immovable and the lower jaw (mandible) which moves vertically and laterally. The jaws are the strongest and largest bones of the facial bones and are moved by four pairs of muscles. The movement of the lower jaw is important not only for mastication but also for vowel production since the movement of the lower jaw changes the size of the oral cavity.

As the fourth articulator, in the gums and the hard palate, the gums are areas where articulation of speech sounds such as / [symbol] /(d)/ or / [symbol] (s)/ occurs, and the hard palate is a hard and somewhat flat portion behind the gums and is an area where articulation of / [symbol] (j)/ sounds occurs.

As the last articulator, the soft palate is classified as a movable articulator. This is because, as muscles of the soft palate contract, velopharyngeal closure occurs, and oral sounds are articulated accordingly.

<Articulation Process>

Among sounds, there are those produced by obstructing the airstream in the oral cavity, or, more precisely, in the central portion of the oral passage, and those produced without obstructing the airstream therein, while the airstream which has passed through the vocal cords passes through the vocal tract. In general, the former is referred to as consonants, and the latter is referred to as vowels.

1) Articulation of Components

Consonants should be examined closely according to the manners and places of articulation. In the International Phonetic Alphabet (IPA) chart, each column represents a place of articulation and each row represents a manner of articulation.

First, when classified according to the manners of articulation, the consonants may be mainly classified as occlusive consonants and constrictive consonants according to the type of obstruction that acts on the airstream in the central portion of the oral passage by which consonants are articulated. The occlusive consonants are sounds produced by completely blocking and then releasing the airstream in the oral cavity, and the constrictive consonants are sounds produced by narrowing a portion of the vocal tract and passing the airstream through the narrowed passage.

The occlusive consonants may further be classified as sounds produced with resonance of the nasal cavity and sounds produced without the resonance of the nasal cavity. Nasal stops, which are produced with resonance of the nasal cavity by completely blocking a portion of the vocal tract and lowering the soft palate at the same time, belong to the former, and oral stops, which are produced while the airstream is prevented from passing through the nasal cavity by blocking the nasal passage by raising the soft palate and bringing the soft palate into contact with the pharyngeal wall, belong to the latter. The oral stops may be considered as stops, plosives, trills, and flaps or taps according to the length and manner of closure.

Also, the constrictive consonants are classified as fricatives and approximants When the passage of the airstream is formed at the side of the tongue, the fricatives and approximants are collectively referred to as laterals.

Also, there are affricates in which the manners of articulation of the occlusive consonants and constrictive consonants are used in combination, and, lastly, there are liquids expressed as “r” or “l” in alphabets but as / [symbol] / in Korean and trills, which do not exist in Korean, produced by the vibrating articulators.

When the consonants are classified according to the places of articulation, bilabials refer to sounds whose articulation involves the two lips. The Korean consonants / [symbol] (b), [symbol] (pp), [symbol] (p), [symbol] (m)/ and the like belong to the bilabials. Although all the bilabials that exist in the modern Korean speech (standard speech) are sounds produced by closing the two lips together, the bilabials may also be produced by narrowing the gap between the two lips and forcing an airstream to pass through the narrowed gap (bilabial fricatives) or may also be produced by quivering the two lips (bilabial trills).

Labiodentals refer to sounds whose articulation involves the lower lip and upper teeth. The labiodentals do not exist in Korean. Although there are no labiodentals in Korean, the English consonants [f, v] belong to the labiodentals (labiodental fricatives).

Dentals refer to sounds in which the narrowing or closure of an airstream occurs at the rear portion of the upper teeth. Since friction occurs between the upper and lower teeth in some cases, the dentals are also referred to as interdentals.

Alveolars refer to sounds produced as the narrowing or closure of an airstream occurs in the vicinity of the upper gums. The Korean consonants / [symbol] (d), [symbol] (tt), [symbol] (t), [symbol] (n), [symbol] (ss), [symbol] (s)/ and the like belong to the alvelars. The Korean consonants / [symbol] (s), [symbol] (ss)/ are sounds produced by the narrowing of the airstream occurring at a portion of the alveolar ridge. Regarding these Korean consonants, the place where the narrowing of the airstream occurs is almost similar to that of the English consonants /s, z/.

Palatoalveolars, which are also referred to as postalveolars, are sounds produced by the tip or blade of the tongue coming into contact with the postalveolar part. The palatoalveolars do not exist in Korean but exist in English or French.

Alveolopalatals are also referred to as prepalatals since the alveolopalatals are articulated from the front side of the hard palate, that is, the side close to the alveolar ridge. The three Korean affricates / [symbol] (j), [symbol] (ch), [symbol] (jj)/ belong to the alveolopalatals.

Retroflexes are clearly different from other lingual sounds, which are articulated by the tip or the dorsal surface of the tongue coming into contact with or approaching the palate, in that the retroflexes are articulated by the ventral surface of the tongue coming into contact with or approaching the palate.

Palatals refer to sounds which are articulated by the body (g)of the tongue coming into contact with or approaching a portion of the hard palate.

Velars refer to sounds which are articulated by the body of the tongue coming into contact with or approaching a portion of the soft palate. The stops / [symbol] (g) [symbol] (k), [symbol] (kk)/ and the nasal / [symbol] (ng)/ in Korean belong to the velars.

Uvulars refer to sounds articulated by the body of the tongue coming into contact with or approaching the uvula, which is an end portion of the soft palate.

Pharyngeals refer to sounds whose articulation occurs in the pharyngeal cavity.

Lastly, glottals refer to sounds articulated with the vocal cords used as the articulators. In Korean, only the glottal voiceless fricative / [symbol] (h)/ exists as a glottal phoneme.

2) Articulation of Vowels

In the articulation of vowels, three variables, the tongue height, the front-back position of the tongue, and the shape of the lips, act as the most important variables.

By the tongue height, which is the first variable, the degree of opening, that is, the degree of opening of the mouth, is determined for vowels. Vowels produced with the mouth slightly open are referred to as close vowels or high vowels, and vowels produced with the mouth widely open are referred to as open vowels or low vowels. Also, vowels produced with the tongue positioned between the open vowels and the close vowels are referred to as mid vowels. The mid vowels may be further divided into close-mid vowels or half-close vowels produced with a smaller degree of opening of the mouth and open-mid vowels or half-open vowels with a larger degree of opening of the mouth.

The front-back position of the tongue, which is the second variable, is in fact determined based on which part of the tongue is narrowed the most, that is, which part of the tongue is closest to the palate. Vowels produced with the most narrowed part of the tongue positioned at the front side of the tongue are referred to as front vowels, vowels produced with the most narrowed part of the tongue positioned at the back side of the tongue are referred to as back vowels, and vowels produced with the tongue positioned between the front vowels and the back vowels are referred to as central vowels.

The last variable important for the articulation of vowels is the shape of the lips. Vowels articulated with the lips rounded and protruding forward are referred to as rounded vowels, and vowels articulated without the lips rounded and protruding forward are referred to as unrounded vowels.

Speech disorders refer to cases in which the pitch, intensity, sound quality, and fluidity of speech are not suitable for gender, age, physique, social environment, and geographical location. Speech disorders may be congenital or acquired and may be treated to some extent by extending or shortening the vocal cords which are part of the larynx. However, the treatment is not perfect, and the effect thereof is not considered to be accurate.

The larynx has functions such as swallowing, coughing, obstruction, breathing, and phonation. There are various evaluation methods (e.g., speech history test, speech pattern test, acoustic test, aerodynamic test, etc.) for evaluating the functions of the larynx. Through the evaluation, whether a person has a speech disorder may be determined to some extent.

There are various types of speech disorders. Speech disorders may be mainly classified as functional speech disorders and organic speech disorders. In most of the types, an abnormality occurs in the vocal cords which are part of the larynx. In many cases, speech disorders are caused by swelling or tearing of the vocal cords or occurrence of abnormal substances in the vocal cords which occurs due to external environmental factors.

In order to replace the function of the vocal cords, a vibration generator capable of artificially generating vibrations may be used. The method of the vibration generator may use the principle of the loudspeaker. The structure of the loudspeaker includes a magnet and a coil. When a direction of current is reversed while the current is caused to flow in the coil, the pole of the magnet is reversed. Therefore, an attractive force or a repulsive force acts in the direction of the current in the magnet and the coil, and this causes the coil to reciprocate. The reciprocation of the coil vibrates air and generates vibration.

A method using the piezoelectric phenomenon is another way of replacing the function of the vocal cords by using the vibration generator. A piezoelectric crystal unit receives low-frequency signal voltages and causes distortion, thereby causing a diaphragm to vibrate and generate sounds. Therefore, the vibration generator using the above principles may be made to perform the function of the vocal cords.

However, in the case of using the vibration generator, since the vibration generator is positioned outside the vocal cords and merely vibrates the vocal cords, not only the sounds produced are very inaccurate, but it is also difficult to identify the speaker's intention of speech. Also, since the vibration generator should always be carried in the form of being located at the vocal cords and thus requires one hand to be used for holding the vibration generator during speaking, the vibration generator causes inconvenience in everyday life. For the above-mentioned speech disorders and speech abnormalities, therapeutic methods such as surgery on portions of the larynx or vocal cords may be considered. However, such surgical methods or treatments are not the perfect solution since those are impossible in some cases.

Particularly, electropalatography (EPG) systems which have been developed in the related industry around the Europe and Hong Kong include WinEPG developed at the University of Reading and Articulate Instruments Ltd., The Rion EPG developed in 1973 by Fujimura Tatsumi of Japan and widely commercialized by the name of the Rion corporation, Kay Palatometer which has been in use after being applied for patent by Flecher and developed by the UCLA Phonetics Lab for the purpose of research, and Complete Speech (formerly Logometrix) developed by Schmidt.

However, the conventional techniques have a limitation in implementing speech based on passive articulators and have an obvious limitation in implementing speech using the oral tongue, which itself is an active articulator, or implementing speech according to the actual manners of articulation by association between the oral tongue and other articulators.

Conventionally, various sensors for grasping a state change or movement have been developed. Changes in pressure, temperature, distance, friction, and the like can be grasped on the basis of the sensors.

Further, lip synchronization (lip sync) is a key means of determining and expanding an individual's identity by replicating and applying speech including talking voice and articulation, facial expression, and the like, which are the most important factors in determining an identity of a target or an object, to characters, robots, various electronic appliances, autonomous driving vehicles, and the like. Particularly, that task of creating a high-quality lip sync animation, which is performed by a professional animation team, requires high cost and long time and involves a large amount of work, thus being difficult. Conventional general techniques merely involve using a library of lip shapes and creating low-quality animations. Overseas animation content producers such as Pixar and Disney spend much time and money creating realistic character animations through lip sync.

### DISCLOSURE

### Technical Problem

The present invention is directed to providing a speech complementation device and a method thereof capable of grasping a manner of articulation of a user according to an intention of speech of the user by using head and neck sensors including the oral tongue and showing the grasped manner of articulation in aural, visual, and tactile forms to form a good-quality voice, that is, produce good-quality phonation.

The present invention is also directed to implementing good-quality, proper speech when a user is unable to perform normally in terms of speech and correction or treatment is impossible.

The present invention is also directed to providing a speech complementation device, which is disposed inside or outside the head and neck, and a control method thereof capable of allowing accurate speech, which is at a level desired by a user, to be produced to the outside according to an intention of articulation for speech.

The present invention is also directed to providing a method of grasping a manner of articulation of a user according to an intention of speech of the user by using head and neck sensors including the oral tongue, and mapping the grasped manner of articulation onto the head and neck of an image object including an animation to implement speech and facial expressions of the corresponding image object in ways more natural and similar to humans.

The present invention is also directed to providing a method of grasping a manner of articulation of a user according to an intention of speech of the user by using head and neck sensors including the oral tongue, and mapping the grasped manner of articulation onto an actuator of the head and neck of a robot, including a humanoid, to implement speech and facial expressions by the head and neck of the corresponding robot in ways more natural and similar to humans.

Other objectives and advantages of the present invention will become more clear through the detailed description below and the accompanying drawings.

### Technical Solution

The present invention provides a speech intention expression system including a sensor part which is adjacent to one surface of the head and neck of a speaker and measures physical characteristics of articulators, a data interpretation part which grasps an articulatory feature of the speaker on the basis of the position of the sensor part and the physical characteristics of the articulators, a data conversion part which converts the position of the sensor part and the articulatory feature into speech data, and a data expression part which expresses the speech data to the outside, wherein the sensor part includes an oral tongue sensor corresponding to the oral tongue.

The oral tongue sensor may be fixed to one side surface of the oral tongue, surround a surface of the oral tongue, or be inserted into the oral tongue and grasp a change in vector quantity with time based on x-axis, y-axis, and z-axis directions of the oral tongue according to speech so that at least one physical characteristic among the height, frontness or backness, degree of curve, degree of stretch, degree of rotation, degree of tension, degree of contraction, degree of relaxation, and degree of vibration of the oral tongue may be grasped.

The oral tongue sensor may be fixed to one side surface of the oral tongue, surround a surface of the oral tongue, or be inserted into the oral tongue and grasp a change in angle of rotation per unit time based on x-axis, y-axis, and z-axis directions of the oral tongue according to speech so that the physical characteristics of the articulators including the oral tongue may be grasped.

The oral tongue sensor may be fixed to one side surface of the oral tongue or surround a surface of the oral tongue and grasp the degree of bending of the oral tongue using a piezoelectric element in which an electrical signal corresponding to polarization caused by a change in a crystal structure is generated according to a physical force which is generated due to contraction and relaxation of the oral tongue according to speech so that at least one physical characteristic among the height, frontness or backness, degree of curve, degree of stretch, degree of rotation, degree of tension, degree of contraction, degree of relaxation, and degree of vibration of the oral tongue may be grasped.

The sensor part may include a triboelectric element which grasps at least one physical characteristic among the degree of plosion, degree of friction, degree of resonance, and degree of approach of the oral tongue according to a triboelectric generator which corresponds to approach and contact caused by interaction between the oral tongue and another articulator inside or outside the head and neck.

The data interpretation part may grasp at least one articulatory feature of consonants and vowels, lexical stress, and tonic stress, which are spoken by the speaker, through physical characteristics of the oral tongue and another articulator measured by the sensor part.

In grasping the articulatory feature through the physical characteristics of the articulators measured by the sensor part, the data interpretation part may measure at least one articulatory feature among the degree of rightness/wrongness of the pronunciation and stress, degree of similarity/contiguity, and intention of speech of the speaker on the basis of a standard articulatory feature matrix formed of numerical values including binary numbers or real numbers.

In grasping the articulatory feature through the physical characteristics of the articulators measured by the sensor part, the data interpretation part may grasp the articulatory features according to an operation of recognizing the physical characteristics of the articulators as patterns of consonant and vowel units, an operation of extracting features of the patterns of the consonant and vowel units and classifying the extracted features of the patterns of the consonant and vowel units according to the degree of similarity, an operation of recombining the classified features of the patterns of the consonant and vowel units, and an operation of interpreting the physical characteristics of the articulators as the articulatory features.

Using the physical characteristics of the articulators measured by the sensor part, the data interpretation part may measure at least one articulatory variation, which is a secondary articulation phenomenon, among asperation, syllabic consonant, flapping, tensification, labilalization, velarization, dentalization, palatalization, nasalization, stress shift, and lengthening which are caused by assimilation, dissimilation, elision, attachment, stress, and reduction of consonants and vowels.

The oral tongue sensor may include a circuit part for sensor operation, a capsule part which surrounds the circuit part, and an adhesive part attached to one surface of the oral tongue.

The oral tongue sensor may be in the form of a film having a thin film circuit and be operated adjacent to the oral tongue.

The sensor part may include at least one reference sensor which generates a reference potential for measurement of neural signals of head-and-neck muscles and facial sensors including at least one positive electrode sensor and at least one negative electrode sensor which measure the neural signals of the head-and-neck muscles.

In obtaining the position of the sensor part on the basis of the facial sensor, the data interpretation part may grasp a potential difference between the at least one positive electrode sensor and the at least one negative electrode sensor on the basis of the reference sensor to grasp positions of the facial sensors.

In obtaining the articulatory feature of the speaker on the basis of the facial sensors, the data interpretation part may grasp a potential difference between the at least one positive electrode sensor and the at least one negative electrode sensor on the basis of the reference sensor to grasp the articulatory feature due to the physical characteristics of the articulators that occur in the head and neck of the speaker.

The sensor part may include a vocal cord sensor which is adjacent to the vocal cords in the head and neck of the speaker and grasps an electromyogram or trembling of the vocal cords to grasp at least one piece of speech history information among a start of speech, a pause of speech, and an end of speech of the speaker.

The sensor part may include a teeth sensor which is adjacent to one surface of the teeth and grasps a signal generation position according to a change in electric capacitance which occurs due to contact between the oral tongue and the lower lip.

The data interpretation part may acquire a voice of the speaker according to speech by using a voice acquisition sensor adjacent to one surface of the head and neck of the speaker.

The sensor part may include an imaging sensor which images the head and neck of the speaker in order to grasp at least one of information on changes in the head and neck articulators of the speaker, information on changes in facial expressions made by the head and neck of the speaker, and nonverbal expressions of the head and neck, chest, arms, and legs which move according to an intention of speech of the speaker.

The speech intention expression system may further include a power supply which supplies power to at least one of the oral tongue sensor, a facial sensor, a voice acquisition sensor, a vocal cord sensor, a teeth sensor, and an imaging sensor of the sensor part.

The speech intention expression system may further include a wired or wireless communication part which, when the data interpretation part and a database part operate while being disposed outside, is linked to and communicates with the data interpretation part and the database part.

The data interpretation part may be linked to the database part which includes at least one speech data index corresponding to the position of the sensor part, the articulatory feature of the speaker, and a voice of the speaker.

On the basis of at least one piece of information among time duration of speech, frequency according to the speech, amplitude of the speech, electromyogram of head-and-neck muscles according to the speech, a change in positions of the head-and-neck muscles according to the speech, and a change in a position of the oral tongue due to bending and rotation, the database part may, form at least one speech data index among a consonant-and-vowel phoneme unit index, a syllable unit index, a word unit index, a phrase unit index, a sentence unit index, a consecutive speech unit index, and a pronunciation height index.

The data expression part may be linked to a speech data index of the database part and show the articulatory feature of the speaker as at least one speech expression among a consonant-and-vowel phoneme unit, at least one word unit, at least one phrase unit (citation forms), at least one sentence unit, and a consecutive speech unit.

The speech expression shown by the data expression part may be visualized in at least one of an alphabet, a figure, a special symbol, and a number or auralized in a form of a sound to be provided to the speaker and a listener.

The speech expression shown by the data expression part may be provided to the speaker and a listener by using at least one tactile method among vibrating, snoozing, tapping, pressing, and relaxing.

The data conversion part may convert the position of the sensor part and information on changes in facial expressions made by the head and neck into first base data and convert the articulatory feature, information on changes in the articulators, and the information on the changes in the facial expressions made by the head and neck into second base data to generate object head-and-neck data required for at least one object of an image object's head and neck and a robot object's head and neck.

The speech intention expression system may further include a data matching part which, in expressing the object head-and-neck data processed by the data interpretation part to the image object's head and neck or the robot object's head and neck, sets static basic coordinates on the basis of the first base data of the data conversion part and sets dynamic variable coordinates on the basis of the second base data to generate a matching position.

The object head-and-neck data may be transmitted to an actuator disposed at one surface of the robot object's head and neck by the data matching part, and the actuator may implement movement of the robot object's head and neck, including at least one of articulation, speech, and facial expressions, according to the object head-and-neck data.

### Advantageous Effects

A speech intention expression system based on physical characteristics of head and neck articulators according to the present invention has an advantageous effect of being able to form good-quality speech, that is, produce good-quality phonation, by grasping an intention of speech by utilizing head and neck articulators relating to the oral tongue of a speaker and showing the grasped intention of speech in aural, visual, and tactile forms.

In the present invention, articulators inside and outside the head and neck, including the oral tongue, are used to grasp an intention of speech. For example, one or more characteristics among the degree of closure, degree of plosion, degree of friction, degree of resonance, and degree of approach caused by an independent physical characteristic of the oral tongue or an interaction between the oral tongue and one or more articulators among passive articulators and one or more active articulators including the lips, glottis, vocal cords, pharynx, and epiglottis should be grasped, and, in order to grasp such characteristics, various sensors capable of grasping azimuth, angle of elevation, angle of rotation, pressure, friction, distance, temperature, sound, and the like are used.

In the case of artificial vocal cords which have been proposed previously, a sound is produced from outside through vibration and there are disadvantages in that movement of one hand is unnatural and the quality of speech is very low. In the case of an artificial palate, there is a disadvantage of depending on the hard palate, which is a passive articulator.

Further, although, phonetically, articulatory phonetics which seeks to measure speech of a speaker by utilizing an artificial palate has been acknowledged as the mainstream so far, the articulatory phonetics is only able to grasp the presence or absence of discrete speech in speech according to articulation of specific consonants and vowels in speech measurement. However, the argument of the articulatory phonetics has raised academic questions due to acoustic phonetics which argues that human speech does not have a discrete feature and, in each phoneme, particularly, in vowels, each vowel is consecutive and thus cannot exist in a segmented state or be pronounced in a segmented state. Specifically, the acoustic phonetics argues that human speech cannot be discretely classified as “one speaks” or “one could not speak,” and, instead, the human speech has proportional, phased characteristics according to the degree of similarity.

Thus, the acoustic phonetics scales physical characteristics of speech sounds themselves according to speech of a speaker and grasps the degree of similarity or degree of proximity, thereby leaving the door open for speech measurement according to the proportional, phased degree of similarity of pronunciations that cannot be implemented by the conventional articulatory phonetics.

With reference to the related technology trend and related academic background, it can be said that the present invention has a very remarkable advantage of being able to, on the basis of the articulatory phonetics, more accurately grasp and implement an intention of speech according to scaling of articulation that is sought by the acoustic phonetics.

Specifically, in the present invention, since the degree of articulation that occurs due to actions of articulators of a speaker is scaled and intuitively provided in aural, visual, and tactile forms, the quality of communication and convenience in life are expected to be significantly improved.

Further, when an intention of speech according to speech of a speaker is expressed using text, application of speech-to-text may allow silent speech. In this way, when communicating with a hearing-impaired person, since a speaker speaks and a hearing-impaired person recognizes the speech as a visual material, communication difficulties are eliminated. Further, silent speech may be utilized in public transportation, public facilities, military installations and operations, underwater activities and the like during which communication is affected by noise.

Further, by imaging the exterior of the head and neck articulators of a speaker that change according to speech, correlation between the speech and external changes to the articulators according to the speech may be grasped, and, in this way, the present invention may be utilized in linguistics, complementary communication, and implementation of faces of humanoids.

Particularly, in the animation and film production industry, so far, it has been difficult to achieve synchronization between speech and a facial expression of an image object including an animation character. The most problematic areas are functioning of the articulators and speech. Due to incapability of properly reflecting physical characteristics of the complex human articulators, even huge companies such as Walt Disney and Pixar are at a level of development where characters just open and close the mouth, and the degree of synchronization between lines, speech, and a facial expression is low. To address these problems, high cost is paid to an image production team, and feature points are attached throughout the body of voice actors or motion-capture actors. However, this method does not solve the fundamental part related to speech or facial expressions of an image object and has a limitation in that it mainly focuses on expressing large movements throughout the body. However, in the present invention, physical characteristics of articulators of a real human speaker are measured and mapped onto the head and neck of an image object, thereby allowing speech or facial expressions of the image object to be implemented similar to those of the actual human speaker.

Particularly, in the present invention, speaker articulation information is transmitted to an actuator which implements movements of the head and neck of a robot object and matched, thereby reproducing the head-and-neck movement, including articulation, speech, and facial expressions, of a robot similar to a human speaker. There is an advantageous effect in that it is possible to overcome “Uncanny Valley,” which is chronic cognitive dissonance caused by humanoid robots in humans, that has been argued by Mori Masahiro of Japan. Further, since implementation of human-friendly articulation becomes possible for humanoids and other general robots, there are advantageous effects in that robots and androids may replace the role of humans, and furthermore, human-robot conversation is achieved such that elderly isolation and mental/psychological diseases such as depression of the elderly in the aging society which are caused by an increase in elderly population due to aging can be prevented.

### DESCRIPTION OF DRAWINGS

FIG. 1 is a view illustrating a sensor part of a speech intention expression system according to a first embodiment of the present invention.

FIG. 2 is a view illustrating a position of the sensor part of the speech intention expression system according to the first embodiment of the present invention.

FIG. 3 is a view illustrating the speech intention expression system according to the first embodiment of the present invention.

FIG. 4 is a view illustrating names of areas of the oral tongue utilized in the speech intention expression system according to the first embodiment of the present invention.

FIG. 5 is a view illustrating actions of the oral tongue for speaking vowels that is utilized in the speech intention expression system according to the first embodiment of the present invention.

FIGS. 6 to 10 are views illustrating various oral tongue sensors of the speech intention expression system according to the first embodiment of the present invention.

FIGS. 11 and 12 are a cross-sectional view and a perspective view, respectively, of an attachment state of the oral tongue sensor of the speech intention expression system according to the first embodiment of the present invention.

FIG. 13 is a view illustrating a circuit part of the oral tongue sensor of the speech intention expression system according to the first embodiment of the present invention.

FIG. 14 is a view illustrating various use states of the oral tongue sensor of the speech intention expression system according to the first embodiment of the present invention.

FIG. 15 is a view illustrating a speech intention expression system according to a second embodiment of the present invention.

FIG. 16 is a view illustrating a principle by which a data interpretation part of the speech intention expression system according to the second embodiment of the present invention grasps articulatory features.

FIG. 17 is a view illustrating a principle by which the data interpretation part of the speech intention expression system according to the second embodiment of the present invention grasps measured physical characteristics of articulators as articulatory features.

FIG. 18 is a view illustrating a standard articulatory feature matrix related to vowels that is utilized by the data interpretation part of the speech intention expression system according to the second embodiment of the present invention.

FIG. 19 is a view illustrating a standard articulatory feature matrix related to consonants that is utilized by the data interpretation part of the speech intention expression system according to the second embodiment of the present invention.

FIG. 20 is a view illustrating an algorithm process that is utilized by the data interpretation part of the speech intention expression system according to the second embodiment of the present invention in order to grasp physical characteristics of articulators as articulatory features.

FIG. 21 is a view specifically illustrating the algorithm process that is utilized by the data interpretation part of the speech intention expression system according to the second embodiment of the present invention in order to grasp physical characteristics of articulators as articulatory features.

FIG. 22 is a view specifically illustrating a principle of the algorithm process that is utilized by the data interpretation part of the speech intention expression system according to the second embodiment of the present invention in order to grasp physical characteristics of articulators as articulatory features.

FIG. 23 is a view illustrating an algorithm process by which an oral tongue sensor of the speech intention expression system according to the second embodiment of the present invention grasps specific spoken vowels as articulatory features.

FIG. 24 is a view illustrating a case in which the data interpretation part of the speech intention expression system according to the second embodiment of the present invention utilizes alveolar stops.

FIG. 25 is a view illustrating a case in which the data interpretation part of the speech intention expression system according to the second embodiment of the present invention utilizes bilabial stops.

FIG. 26 is a view illustrating experimental results of the data interpretation part of the speech intention expression system according to the second embodiment of the present invention utilizing voiced bilabial stops.

FIGS. 27 and 28 are views each illustrating a case in which the data interpretation part of the speech intention expression system according to the second embodiment of the present invention utilizes voiced labiodental fricatives.

FIG. 29 is a view illustrating linkage between a database part and the data interpretation part of the speech intention expression system according to the second embodiment of the present invention.

FIG. 30 is a view illustrating a case in which the data interpretation part of the speech intention expression system according to the second embodiment of the present invention grasps specific words.

FIG. 31 is a view illustrating the database part of the speech intention expression system according to the second embodiment of the present invention.

FIG. 32 is a view illustrating a speech intention expression system according to a third embodiment of the present invention.

FIGS. 33 and 34 are views illustrating actual forms of a database part of the speech intention expression system according to the third embodiment of the present invention.

FIG. 35 is a view illustrating a speech intention expression system according to a fourth embodiment of the present invention.

FIG. 36 is a view illustrating linkage among a sensor part, a data interpretation part, a data expression part, and a database part of the speech intention expression system according to the fourth embodiment of the present invention.

FIGS. 37 to 41 are views illustrating means by which the data expression part of the speech intention expression system according to the fourth embodiment of the present invention expresses speech data.

FIG. 42 is a view illustrating a case in which the data expression part of the speech intention expression system according to the fourth embodiment of the present invention visually and aurally expresses speech data.

FIG. 43 is a view illustrating a case in which the data expression part of the speech intention expression system according to the fourth embodiment of the present invention visually expresses speech data.

FIG. 44 is a view illustrating a case in which the data expression part of the speech intention expression system according to the fourth embodiment of the present invention visually expresses speech data.

FIG. 45 is a view illustrating a case in which the data expression part of the speech intention expression system according to the fourth embodiment of the present invention expresses speech data in consecutive speech units.

FIG. 46 is a view illustrating a confusion matrix utilized by the speech intention expression system according to the fourth embodiment of the present invention.

FIG. 47 is a view illustrating the confusion matrix, which is utilized by the speech intention expression system according to the fourth embodiment of the present invention, shown in percentage.

FIG. 48 is a view illustrating a case in which the speech intention expression system according to the fourth embodiment of the present invention helps a speaker with speech correction and guidance through a screen.

FIG. 49 is a view illustrating a case in which the speech intention expression system according to the fourth embodiment of the present invention images and grasps the exterior of the head and neck articulators.

FIG. 50 is a view illustrating a case in which the speech intention expression system according to the fourth embodiment of the present invention combines mutual pieces of information through a standard articulatory feature matrix.

FIG. 51 is a view illustrating a speech intention expression system according to a fifth embodiment of the present invention.

FIG. 52 is a view illustrating a case in which the speech intention expression system according to the fifth embodiment of the present invention matches object head-and-neck data to the head and neck of an image object on the basis of static basic coordinates.

FIG. 53 is a view illustrating static basic coordinates based on positions of facial sensors utilized by the speech intention expression system according to the fifth embodiment of the present invention.

FIG. 54 is a view illustrating a case in which the speech intention expression system according to the fifth embodiment of the present invention matches object head-and-neck data to the head and neck of an image object on the basis of dynamic variable coordinates.

FIG. 55 is a view illustrating dynamic variable coordinates based on voltage differences among facial sensors utilized by the speech intention expression system according to the fifth embodiment of the present invention.

FIG. 56 is a view illustrating a case in which the speech intention expression system according to the fifth embodiment of the present invention matches object head-and-neck data to an actuator of the head and neck of a robot object on the basis of static basic coordinates.

FIG. 57 is a view illustrating the static basic coordinates based on the voltage differences among the facial sensors utilized by the speech intention expression system according to the fifth embodiment of the present invention.

FIG. 58 is a view illustrating a case in which the speech intention expression system according to the fifth embodiment of the present invention matches object head-and-neck data to the actuator of the head and neck of the robot object on the basis of dynamic variable coordinates.

FIG. 59 is a view illustrating the dynamic variable coordinates based on the voltage differences among facial sensors utilized by the speech intention expression system according to the fifth embodiment of the present invention.

FIGS. 60 and 61 are views each illustrating an operation of the actuator of the head and neck of the robot object in the speech intention expression system according to the fifth embodiment of the present invention.

FIG. 62 is a view illustrating the actuator of the head and neck of the robot object in the speech intention expression system according to the fifth embodiment of the present invention.

### MODES OF THE INVENTION

Hereinafter, a speech intention expression system using physical characteristics of head and neck articulators or speech intention expression according to embodiments of the present invention will be described in detail with reference to the accompanying drawings.

The following embodiments of the present invention are merely for embodying the present invention and do not limit or restrict the scope of the present invention. Details that may be easily inferred by those of ordinary skill in the art to which the present invention pertains from the detailed description and embodiments of the present invention should be construed as belonging to the scope of the present invention.

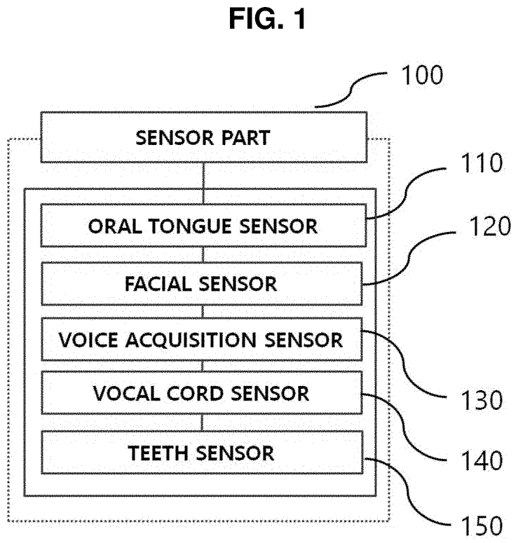

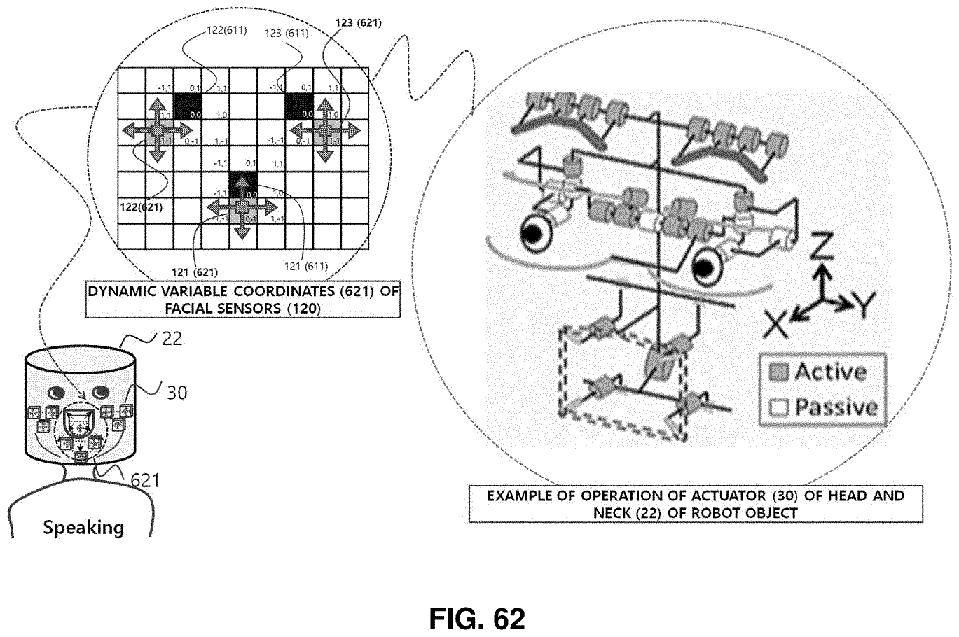

Modes of the present invention will be described in detail with reference to FIGS. 1 to 62.

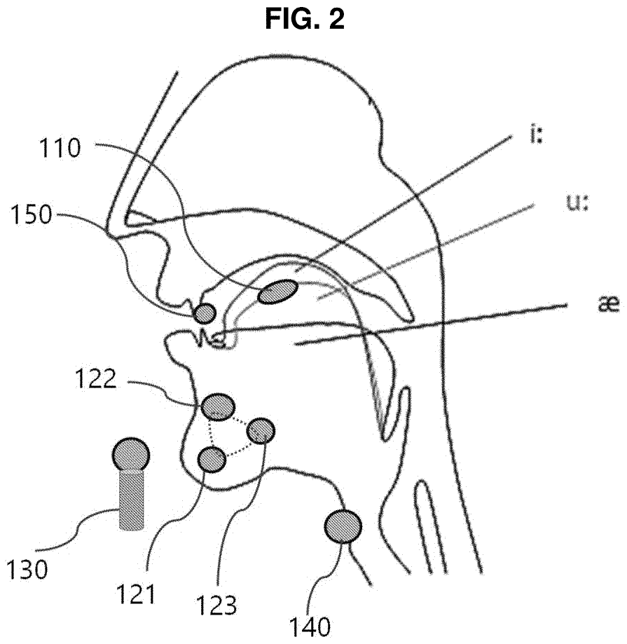

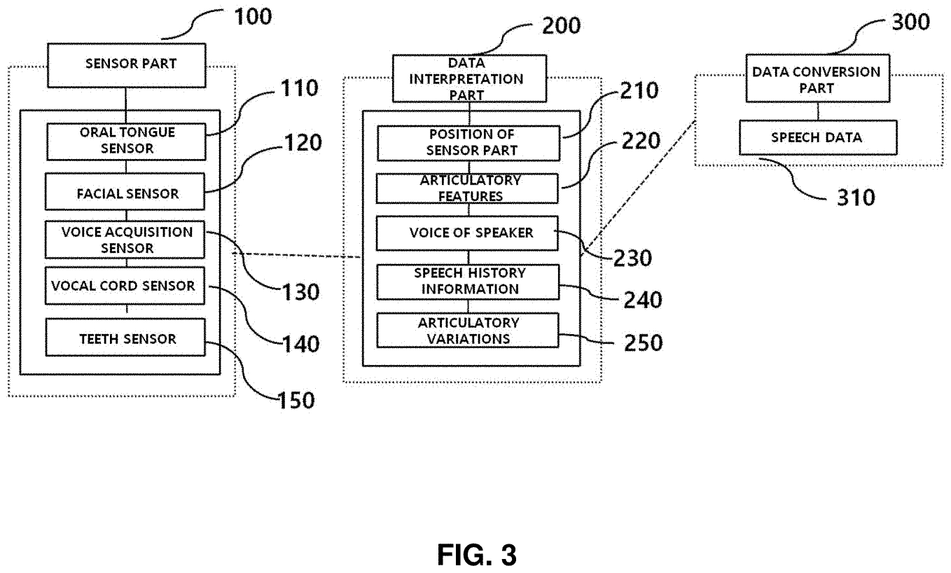

FIG. 1 is a view illustrating a sensor part of a speech intention expression system according to a first embodiment of the present invention, FIG. 2 is a view illustrating a position of the sensor part of the speech intention expression system according to the first embodiment of the present invention, and FIG. 3 is a view illustrating the speech intention expression system according to the first embodiment of the present invention.

As illustrated in FIGS. 1, 2, and 3, in the speech intention expression system according to the first embodiment of the present invention, a sensor part 100 includes an oral tongue sensor 110, facial sensors 120, a voice acquisition sensor 130, a vocal cord sensor 140, and a teeth sensor 150 which are located in the head and neck.

More specifically, the oral tongue sensor 110, the facial sensors 120, the voice acquisition sensor 130, the vocal cord sensor 140, and the teeth sensor 150, which are located in the head and neck, provide data related to a sensor part position 210 at which each sensor is disposed, articulatory features 220 according to speech of a speaker 10, a speaker's voice 230, speech history information 240, and articulatory variations 250.

A data interpretation part 200 acquires such pieces of data, and a data conversion part 300 processes such pieces of data as speech data 310.

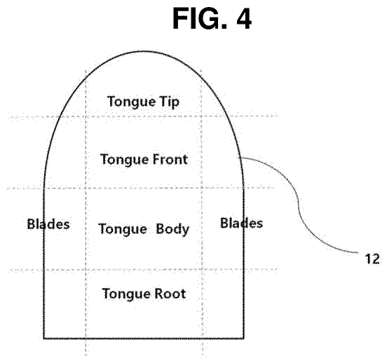

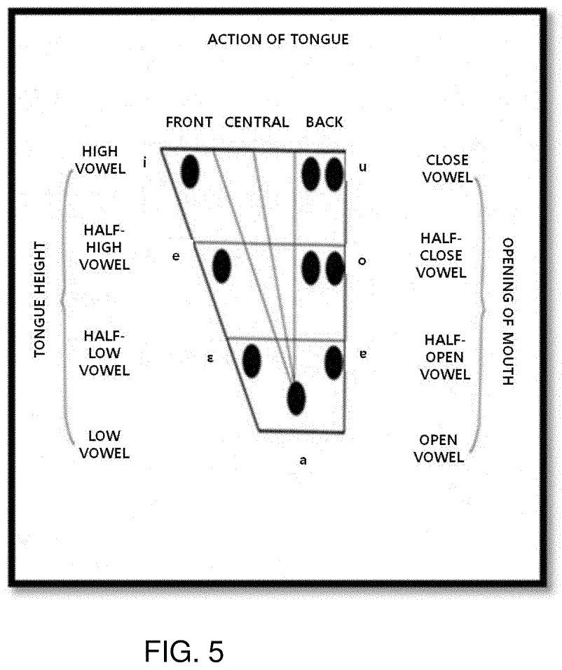

FIG. 4 is a view illustrating names of areas of the oral tongue utilized in the speech intention expression system according to the first embodiment of the present invention, and FIG. 5 is a view illustrating actions of the oral tongue for speaking vowels that is utilized in the speech intention expression system according to the first embodiment of the present invention.

As illustrated in FIGS. 4 and 5, the oral tongue sensor 110 is fixed to one side surface of an oral tongue 12, surrounds a surface of the oral tongue 12, or is inserted into the oral tongue 12 and grasps one or more independent physical characteristics among the height, frontness or backness, degree of curve, degree of stretch, degree of rotation, degree of tension, degree of contraction, degree of relaxation, and degree of vibration of the oral tongue itself.

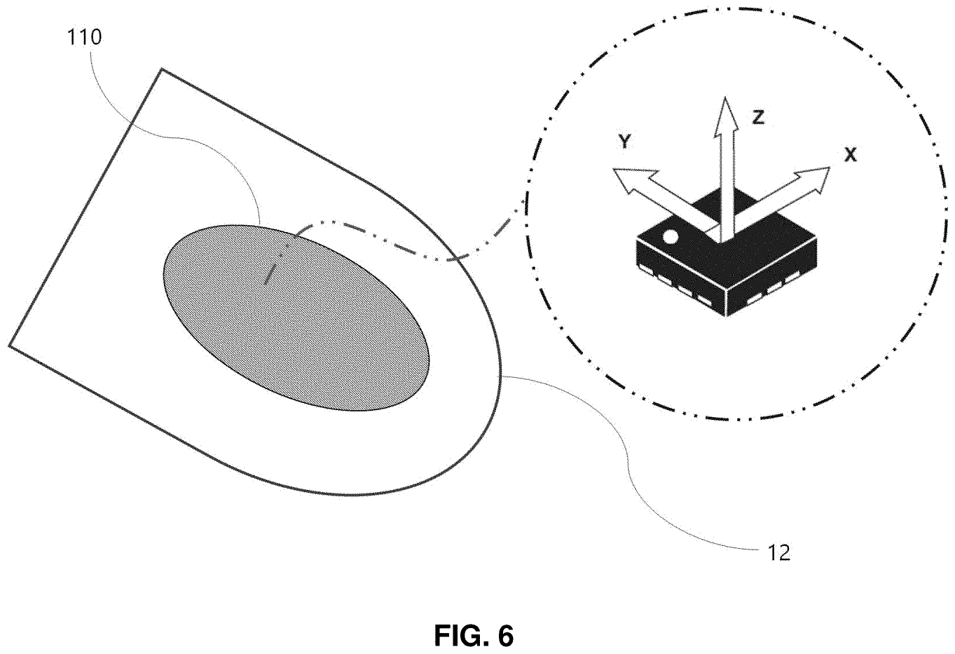

FIGS. 6 to 10 are views illustrating various oral tongue sensors of the speech intention expression system according to the first embodiment of the present invention.

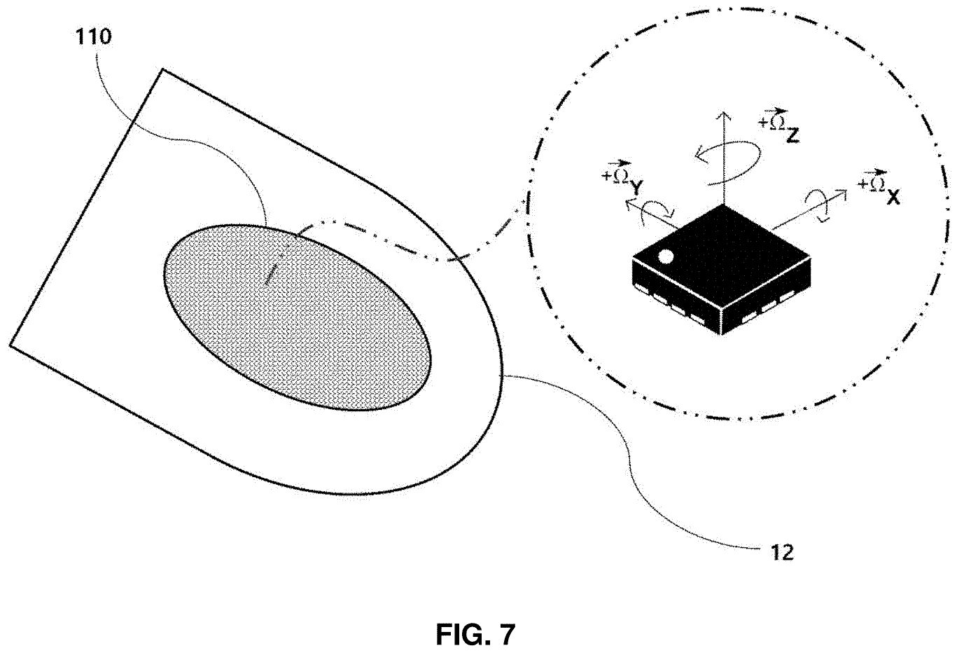

As illustrated in FIGS. 6 and 7, in grasping the independent physical characteristics of the oral tongue 12 itself, the oral tongue sensor 110 may grasp at least one of accelerations and changes in angle of rotation (angular velocity) per unit time in x-axis, y-axis, and z-axis directions, thereby grasping the articulatory features 220 by using physical characteristics of articulators including the oral tongue 12.

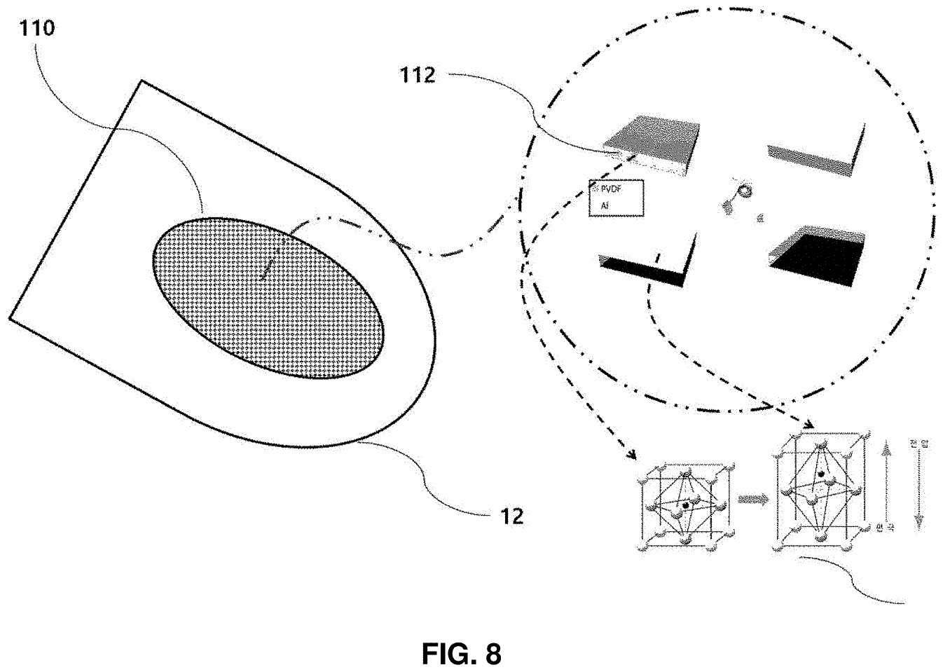

As illustrated in FIG. 8, the oral tongue sensor 110 may grasp the degree of bending of the oral tongue 12 using a piezoelectric element 112 in which an electrical signal is generated due to polarization caused by a change in a crystal structure 111 according to a physical force which is generated due to contraction or relaxation of the oral tongue 12 according to speech, thereby grasping the articulatory features 220 by using the physical characteristics of articulators including the oral tongue 12.

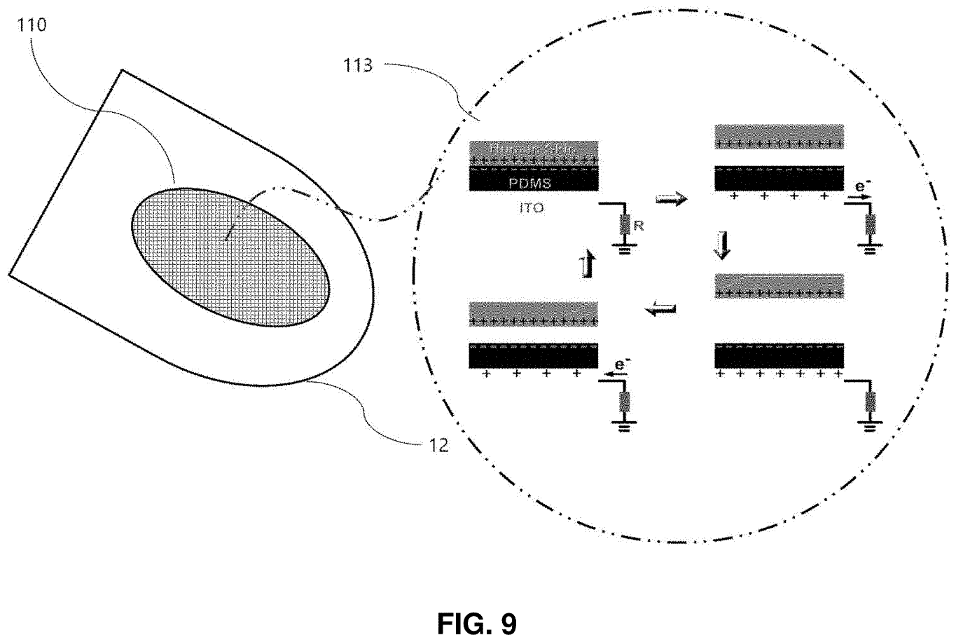

As illustrated in FIG. 9, the oral tongue sensor 110 grasps the articulatory features 220 of the speaker by using a triboelectric element 113 in order to grasp associated physical characteristics according to a triboelectric generator which corresponds to approach and contact caused by interaction between the oral tongue 12 and other articulators inside or outside the head and neck.

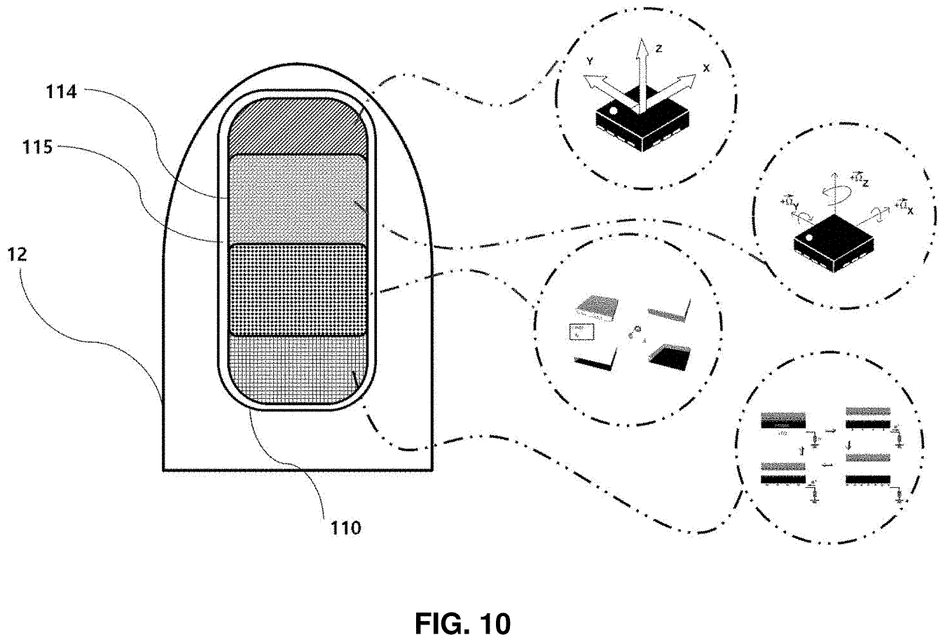

As illustrated in FIG. 10, the integrated oral tongue sensor 10 grasps the articulatory features 220 using the physical characteristics of articulators including the oral tongue 112 by using the acceleration and angular velocity in the x-axis, y-axis, and z-axis directions, an electrical signal due to piezoelectricity, and the triboelectric generator which corresponds to contact.

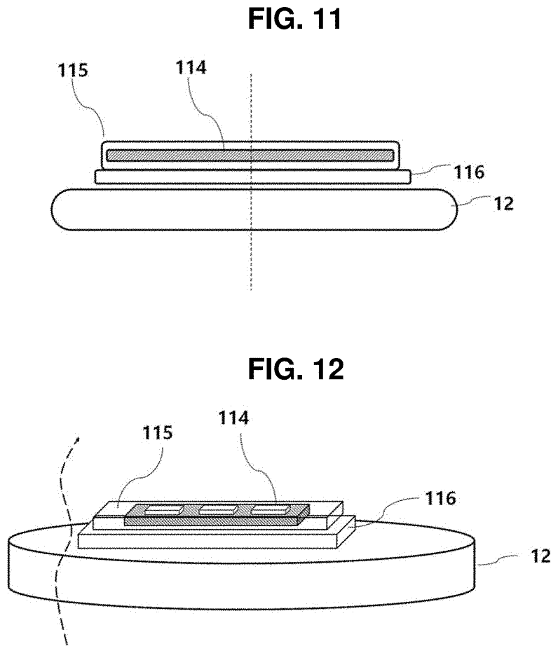

FIGS. 11 and 12 are a cross-sectional view and a perspective view, respectively, of an attachment state of the oral tongue sensor of the speech intention expression system according to the first embodiment of the present invention.

As illustrated in FIGS. 11 and 12, the oral tongue sensor 110 may be formed of a composite thin film circuit and be implemented in the form of a single film. In this case, the oral tongue sensor 110 includes a circuit part 114 for operating the sensor part 100, a capsule part 115 which surrounds the circuit part 114, and an adhesive part 116 fixed to one surface of the oral tongue 12.

As illustrated in FIGS. 6 to 9, the oral tongue sensor 110 may grasp one or more physical characteristics among the degree of plosion, degree of friction, degree of resonance, and degree of approach caused by each sensor being adjacent to or in contact with other articulators inside or outside the head and neck according to features of each sensor.

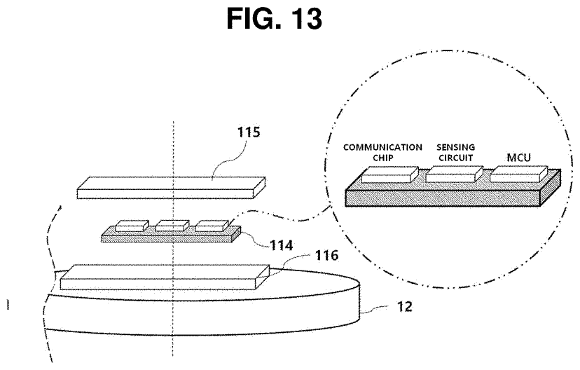

FIG. 13 is a view illustrating a circuit part of the oral tongue sensor of the speech intention expression system according to the first embodiment of the present invention.

As illustrated in FIG. 13, the circuit part 114 of the oral tongue sensor 110 is formed of a communication chip, a sensing circuit, or a main control unit (MCU).

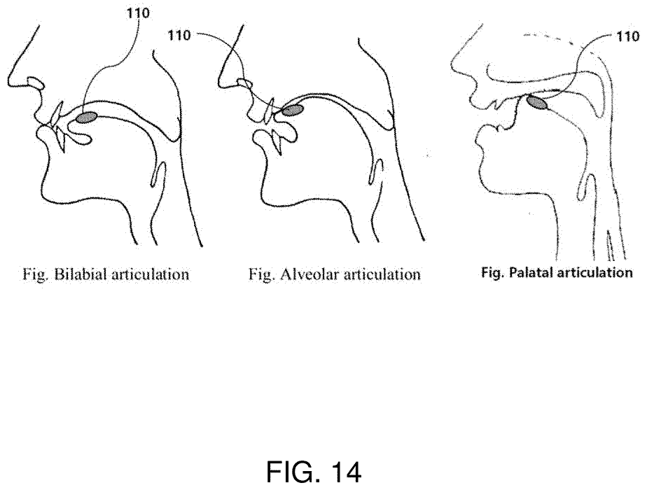

FIG. 14 is a view illustrating various use states of the oral tongue sensor of the speech intention expression system according to the first embodiment of the present invention.

As illustrated in FIG. 14, the oral tongue sensor 110 may grasp a state of the oral tongue 12 according to the speaker speaking various consonants and vowels to grasp the articulatory features 220 according to speaking of consonants and vowels.

For example, the oral tongue sensor 110 may grasp the articulatory features 220 according to a bilabial sound, an alveolar sound, and a palatal sound.

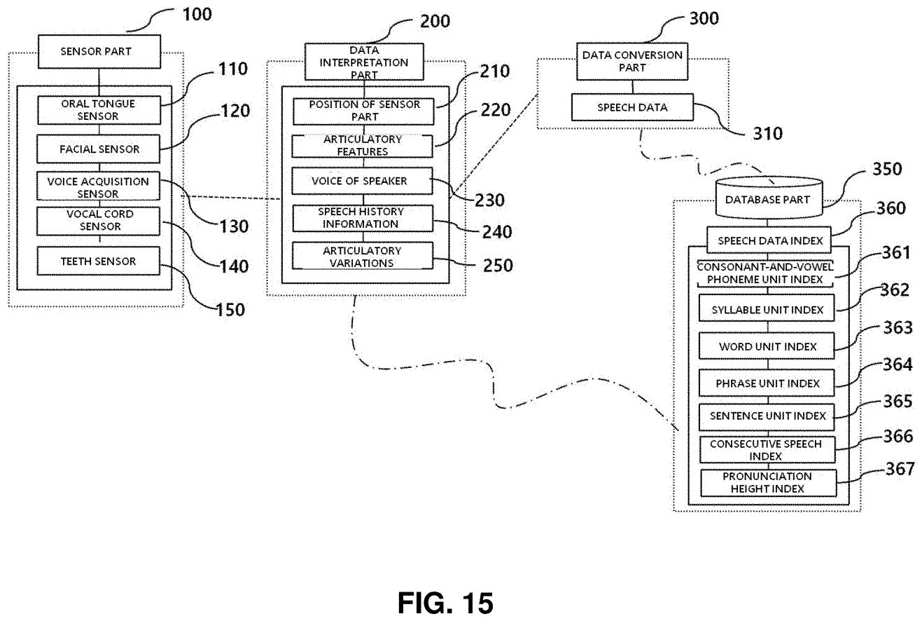

FIG. 15 is a view illustrating a speech intention expression system according to a second embodiment of the present invention.

As illustrated in FIG. 15, in the speech intention expression system according to the second embodiment of the present invention, a sensor part 100 in the vicinity of head and neck articulators that includes an oral tongue sensor 110, facial sensors 120, a voice acquisition sensor 130, a vocal cord sensor 140, and a teeth sensor 150 grasps a sensor part position 210 at which each sensor is disposed, articulatory features 220 according to speech, a speaker's voice 230 according to speech, and speech history information 240 including a start of speech, a pause of speech, and an end of speech.

In this case, the articulatory features 220 refer to one or more fundamental physical articulatory features among a stop-plosive sound, a fricative sound, an affricative sound, a nasal sound, a liquid sound, a glide, a sibilance, a voiced/voiceless sound, and a glottal sound. Also, the speaker's voice 230 is an aural articulatory feature that accompanies the articulatory features. Also, the speech history information 240 is grasped using an electromyogram or trembling of the vocal cords which is detected through the vocal cord sensor 140.

The data interpretation part 200 grasps the articulatory variations 250, which occur according to the speaker's gender, race, age, and native language, from the physical characteristics of articulators of the speaker that are measured by the sensor part 100 in the vicinity of the head neck articulators that is formed of the oral tongue sensor 110, the facial sensors 120, the voice acquisition sensor 130, the vocal cord sensor 140, and the teeth sensor 150.

In this case, the articulatory variations 250 include one or more secondary articulation phenomenons among asperation, syllabic consonant, flapping, tensification, labilalization, velarization, dentalization, palatalization, nasalization, stress shift, and lengthening which are caused by assimilation, dissimilation, elision, attachment, stress, and reduction of consonants and vowels.

The data conversion part 300 recognizes the sensor part position 210, the articulatory features 220 according to speech, the speaker's voice 230 according to the speech, the speech history information 240, and the articulatory variations 250 as speech data 310 and processes the speech data 310.

In this case, in recognizing and processing the speech data 310, the data conversion part 300 is linked to a database part 350.

The database part 350 has speech data indices 360 including a consonant-and-vowel phoneme unit index 361, a syllable unit index 362, a word unit index 363, a phrase unit index 364, a sentence unit index 365, a consecutive speech index 366, and a pronunciation height index 367. Through the speech data indices 360, the data interpretation part 200 may process various pieces of speech-related information acquired by the sensor part 100 as speech data.

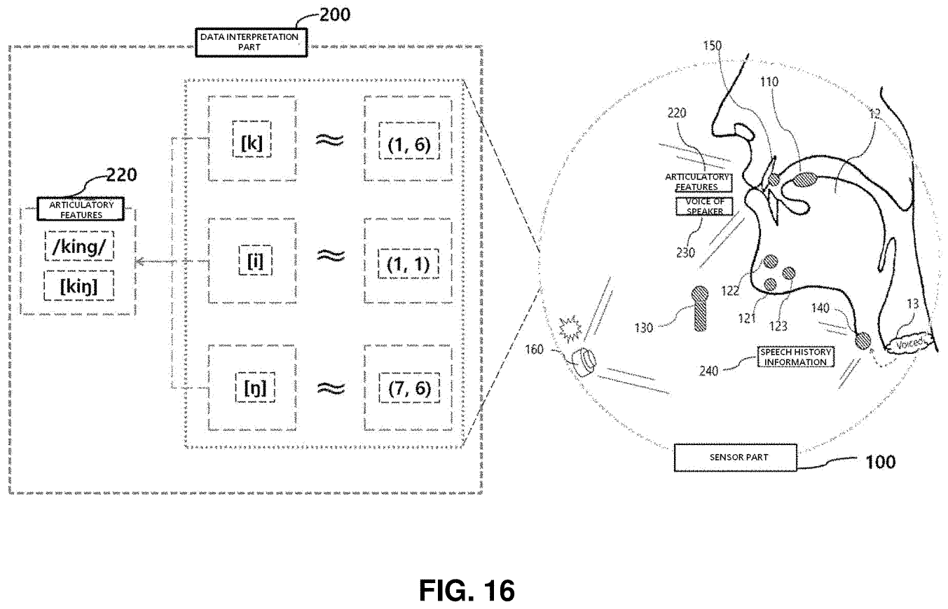

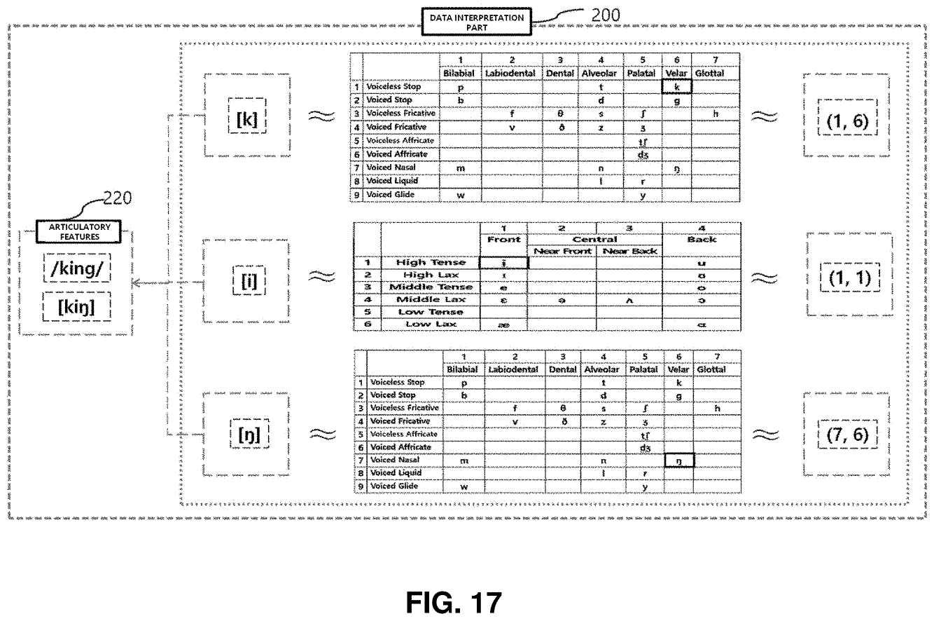

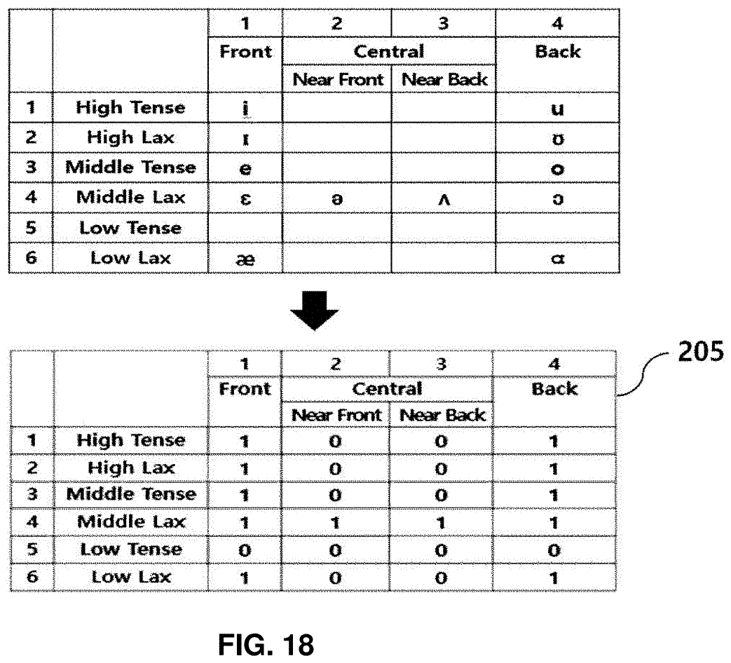

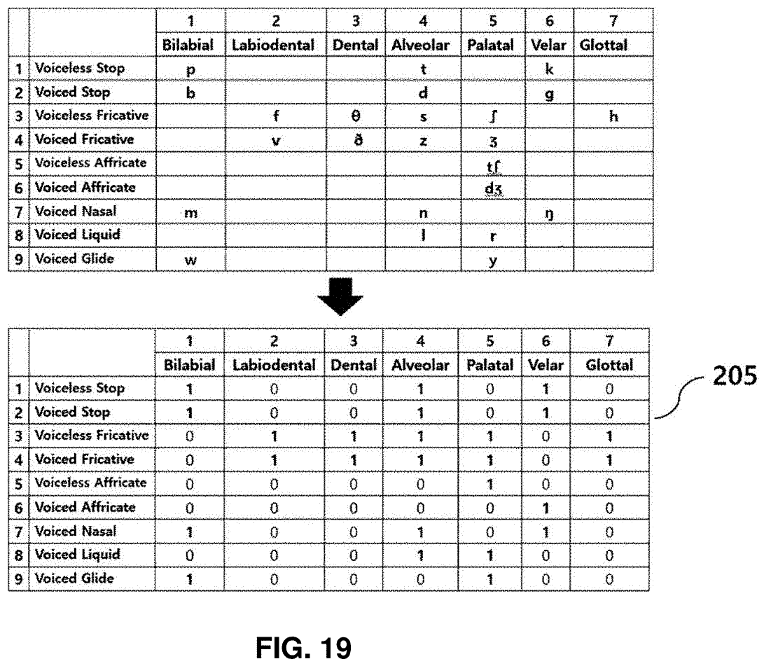

FIG. 16 is a view illustrating a principle by which a data interpretation part of the speech intention expression system according to the second embodiment of the present invention grasps articulatory features, FIG. 17 is a view illustrating a principle by which the data interpretation part of the speech intention expression system according to the second embodiment of the present invention grasps measured physical characteristics of articulators as articulatory features, FIG. 18 is a view illustrating a standard articulatory feature matrix related to vowels that is utilized by the data interpretation part of the speech intention expression system according to the second embodiment of the present invention, and FIG. 19 is a view illustrating a standard articulatory feature matrix related to consonants that is utilized by the data interpretation part of the speech intention expression system according to the second embodiment of the present invention.

As illustrated in FIGS. 16, 17, 18, and 19, the data interpretation part 200 first obtains the physical characteristics of articulators measured by the sensor part 100 including the oral tongue sensor 110. When the physical characteristics of the articulators are obtained by the oral tongue sensor 110, the oral tongue sensor 110 senses the physical characteristics of the articulators and generates matrix values of the sensed physical characteristics.

Then, the data interpretation part 200 grasps the articulatory features 220 of consonants and vowels that correspond to the matrix values of the physical characteristics from a standard articulatory feature matrix 205 of consonants and vowels. In this case, in the standard articulatory feature matrix 205 of consonants and vowels, the values may be one or more of phonetic alphabets of consonants and vowels, binary numbers, or real numbers.

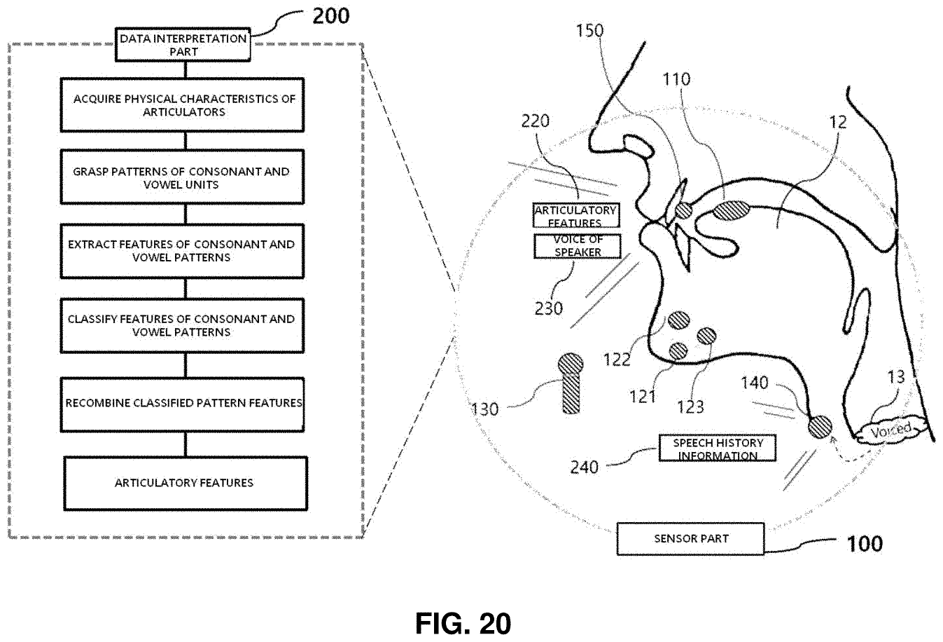

FIG. 20 is a view illustrating an algorithm process that is utilized by the data interpretation part of the speech intention expression system according to the second embodiment of the present invention in order to grasp physical characteristics of articulators as articulatory features.

As illustrated in FIG. 20, the algorithm process utilized by the data interpretation part 200 includes, in grasping the physical characteristics of the articulators measured by the sensor part 100, acquiring the physical characteristics of the articulators, grasping patterns of consonant and vowel units of the acquired physical characteristics of the articulators, extracting unique features from the consonant and vowel patterns, classifying the extracted features, and recombining the classified features of the patterns. In this way, the data interpretation part 200 eventually grasps specific articulatory features.

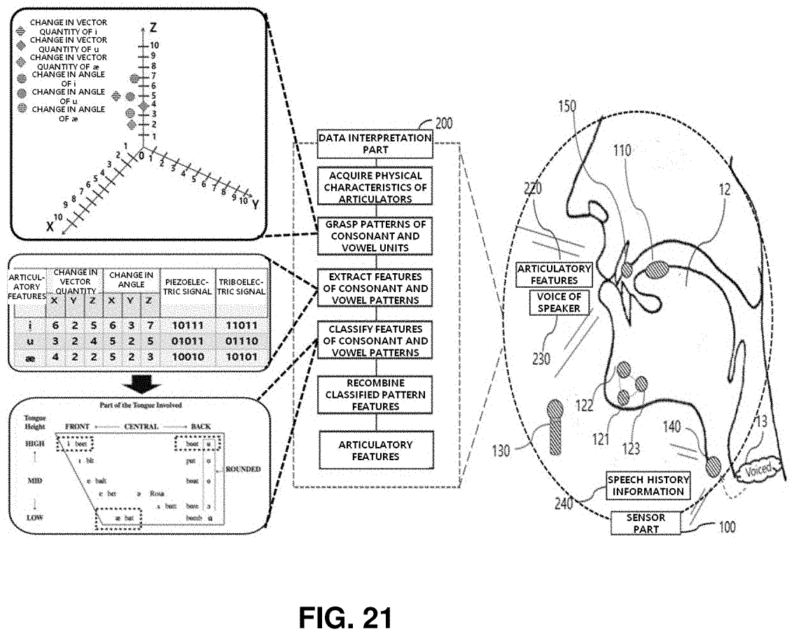

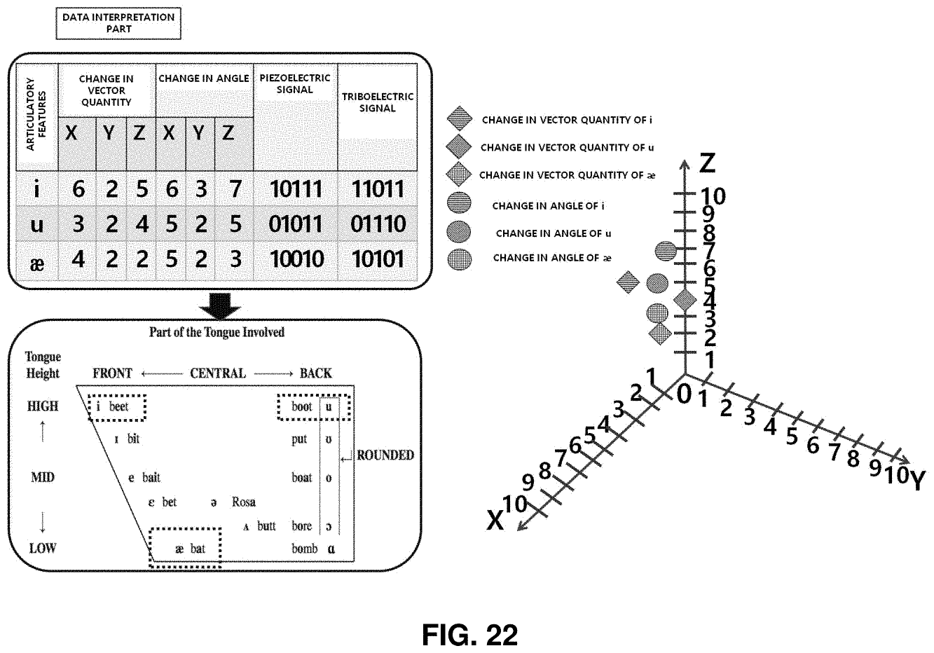

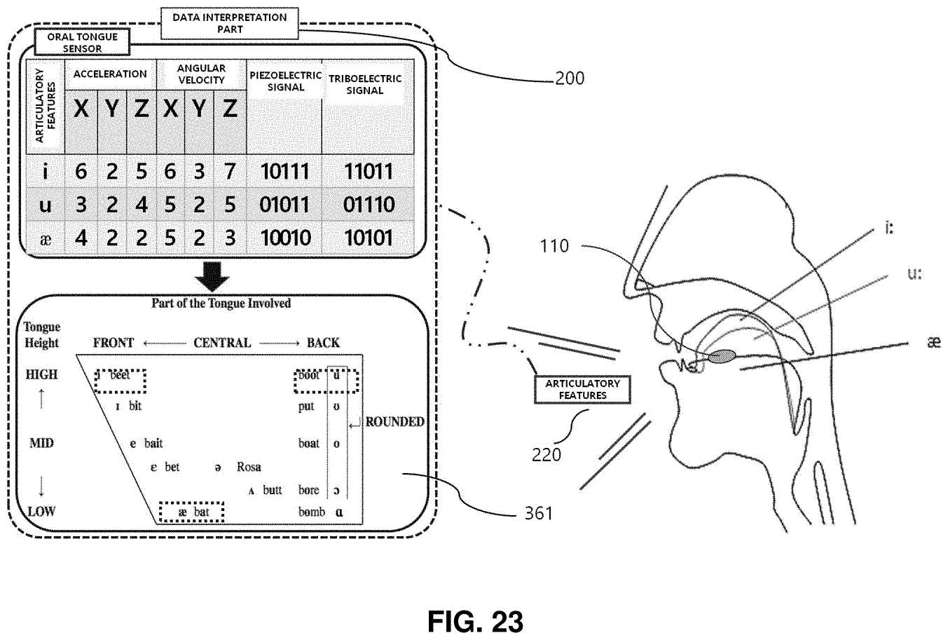

FIG. 21 is a view specifically illustrating the algorithm process that is utilized by the data interpretation part of the speech intention expression system according to the second embodiment of the present invention in order to grasp physical characteristics of articulators as articulatory features, FIG. 22 is a view specifically illustrating a principle of the algorithm process that is utilized by the data interpretation part of the speech intention expression system according to the second embodiment of the present invention in order to grasp physical characteristics of articulators as articulatory features, and FIG. 23 is a view illustrating an algorithm process by which an oral tongue sensor of the speech intention expression system according to the second embodiment of the present invention grasps specific spoken vowels as articulatory features.

As illustrated in FIGS. 21, 22, and 23, in the articulatory feature grasping algorithm performed by the data interpretation part 200, the grasping of the patterns of the consonants and vowels units includes grasping the patterns of the consonant and vowel units on the basis of the x-axis, y-axis, and z-axis when the sensor part 100 which has grasped the physical characteristics of the articulators is the oral tongue 12.

In this case, the algorithm may be based on one or more algorithms among the K-nearest neighbors (KNN) algorithm, the artificial neural network (ANN) algorithm, the convolutional neural network (CNN) algorithm, the recurrent neural network (RNN) algorithm, the restricted Boltzmann machine (RBM) algorithm, and the hidden Markov model (HMM) algorithm.

For example, in FIGS. 22 and 23, when the oral tongue sensor 110 is driven as a sensor for grasping a change in vector quantity or a change in angle, a change in vector quantity and a change in angle are grasped by measuring speech of a speaker, and, in this way, the vowel having a high tongue height and tongue frontness is recognized.

Also, when the oral tongue sensor 110 is a sensor driven by a principle of the piezoelectric signal or triboelectric signal, a change in electrical signal due to piezoelectricity and a triboelectric signal generated due to proximity or friction between the oral tongue sensor 110 and articulators inside or outside the oral cavity are grasped, and the vowel having a high tongue height and tongue frontness is recognized.

Even in the case of the vowel [u], the corresponding vowel is grasped by measuring a high tongue height and tongue backness on the basis of the same principles. Even in the case of the vowel [r], the corresponding vowel is grasped by measuring a low tongue height and tongue frontness on the basis of the same principles.

In FIG. 23, the oral tongue sensor 110 measures vowels such as [i], [u], and [r] generated according to speech of a speaker as the articulatory features 220. The articulatory features 220 of the vowels correspond to the consonant-and-vowel phoneme unit index 361 of the database part 350.

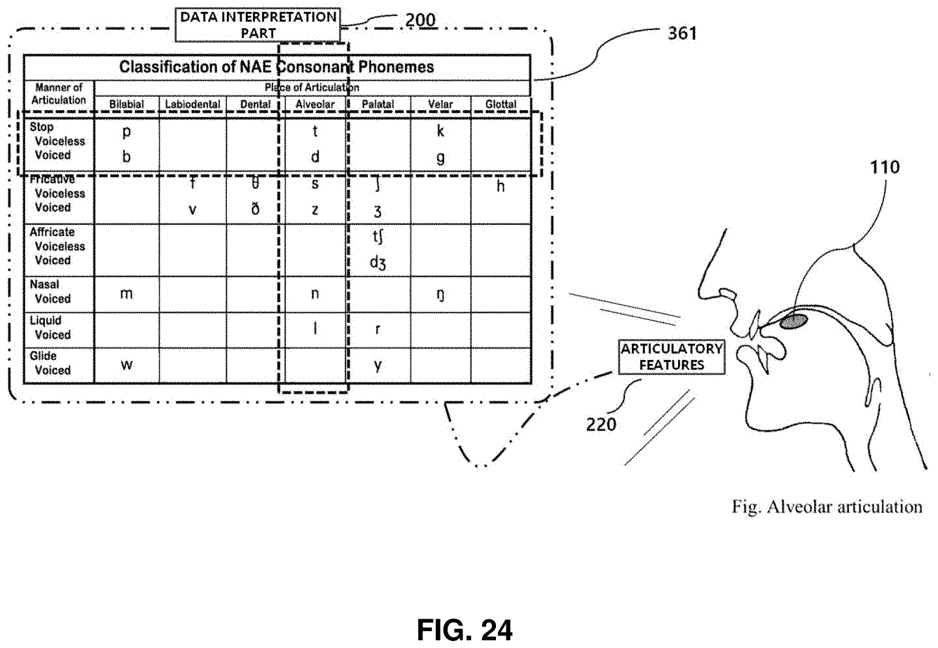

FIG. 24 is a view illustrating a case in which the data interpretation part of the speech intention expression system according to the second embodiment of the present invention utilizes alveolar stops.

As illustrated in FIG. 24, the oral tongue sensor 110 measures specific consonants spoken by a speaker as the articulatory features 220. The articulatory features 220 of the consonants correspond to the consonant-and-vowel phoneme unit index 361 of the database part 350, and the data interpretation part 200 grasps the articulatory features 220 as alveolar stops which are speech data 310.

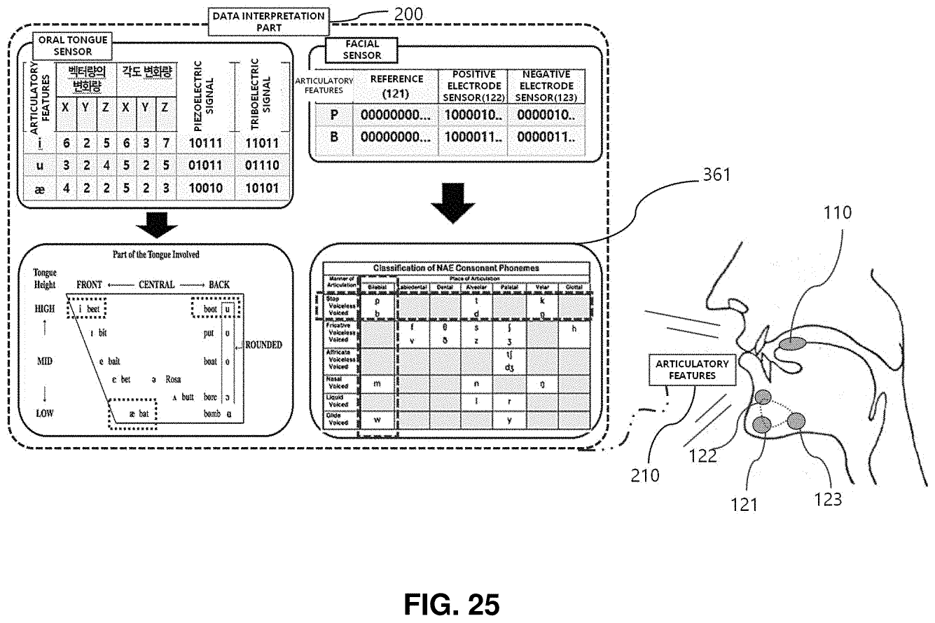

FIG. 25 is a view illustrating a case in which the data interpretation part of the speech intention expression system according to the second embodiment of the present invention utilizes bilabial stops.

As illustrated in FIG. 25, the oral tongue sensor 110 and the facial sensors 120 measure specific consonants spoken by a speaker as the articulatory features 220. The articulatory features 220 of the consonants correspond to the consonant-and-vowel phoneme unit index 361 of the database part 350, and the data interpretation part 200 grasps the articulatory features 220 as bilabial stops which are speech data 310.

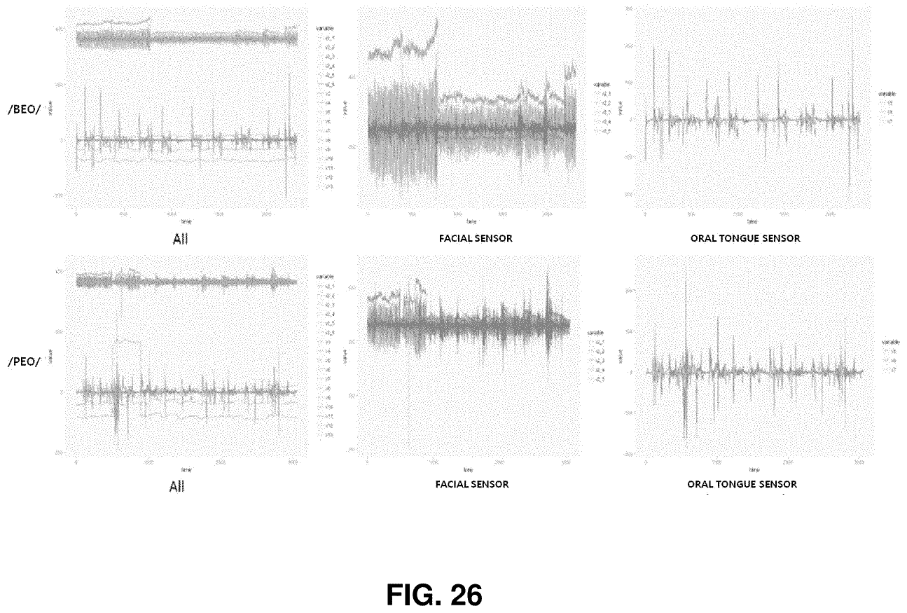

FIG. 26 is a view illustrating experimental results of the data interpretation part of the speech intention expression system according to the second embodiment of the present invention utilizing voiced bilabial stops.

As illustrated in FIG. 26, the oral tongue sensor 110 and the facial sensors 120 measure specific consonants spoken by a speaker as the articulatory features 220. The articulatory features 220 of the consonants correspond to the consonant-and-vowel phoneme unit index 361 of the database part 350, and the data interpretation part 200 grasps the articulatory features 220 as / [symbol] (beo)/, rework which is a voiced bilabial stop, and / [symbol] (peo)/, rework which is a voiceless bilabial stop which are speech data 310.

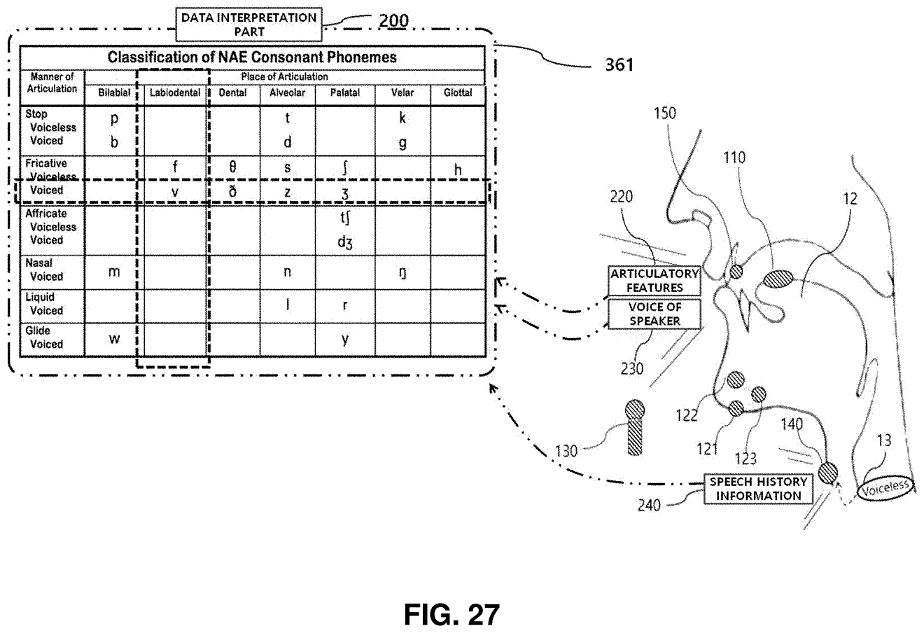

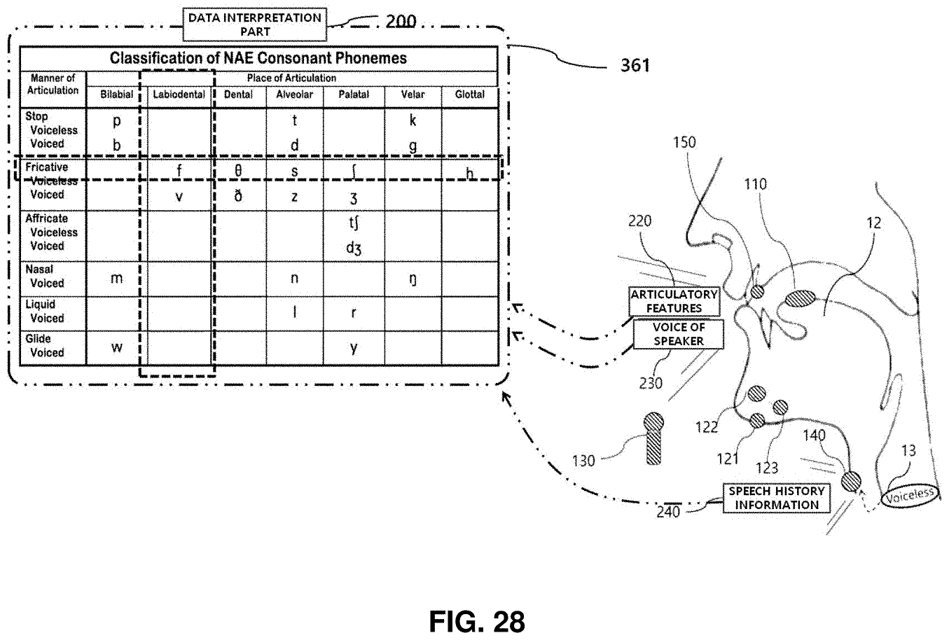

FIGS. 27 and 28 are views each illustrating a case in which the data interpretation part of the speech intention expression system according to the second embodiment of the present invention utilizes voiced labiodental fricatives.

As illustrated in FIGS. 27 and 28, the oral tongue sensor 110, the facial sensors 120, the voice acquisition sensor 130, the vocal cord sensor 140, and the teeth sensor 150 measure specific consonants spoken by a speaker as the articulatory features 220. The articulatory features 220 of the consonants correspond to the consonant-and-vowel phoneme unit index 361 of the database part 350, and the data interpretation part 200 grasps the articulatory features 220 as voiced labiodental fractives which are speech data 310.

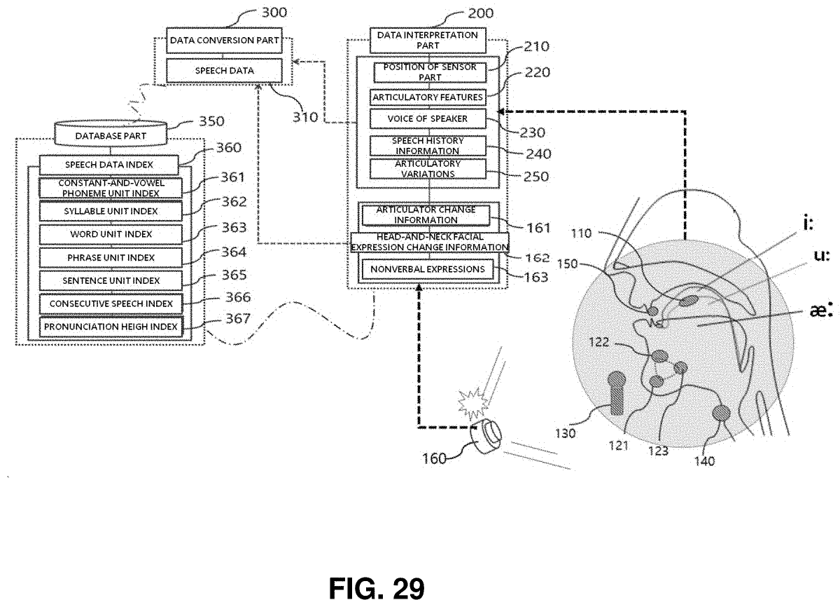

FIG. 29 is a view illustrating linkage between a database part and the data interpretation part of the speech intention expression system according to the second embodiment of the present invention.

As illustrated in FIG. 29, the imaging sensor 160 recognizes head-and-neck articulator change information 161, head-and-neck facial expression change information 162, and nonverbal expression information 163, which are generated when a speaker speaks in a situation in which one or more of the oral tongue sensor 110, the facial sensors 120, the voice acquisition sensor 130, the vocal cord sensor 140, and the teeth sensor 150 are in use, as voice data 310 and processes the voice data 310.

Particularly, the facial sensors disposed at one side of the head and neck provide positions thereof by utilizing potential differences among an positive electrode sensor 122, a negative electrode sensor 123, and a reference sensor 121, and the provided positions are transmitted to the data conversion part 300 as the speech data 310, together with the physical head-and-neck articulator change information 161, the head-and-neck facial expression change information 162, and the nonverbal expression information 163 which are grasped by imaging by the imaging sensor 160.

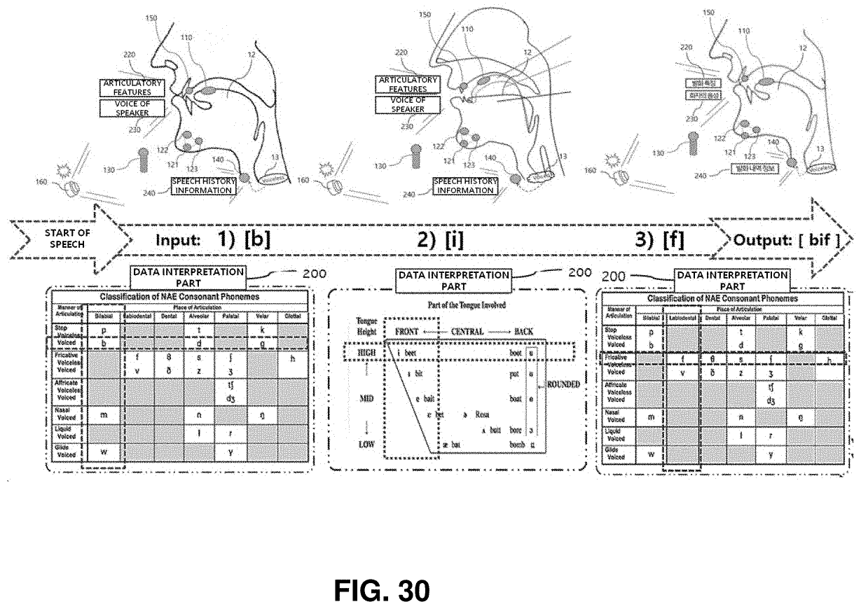

FIG. 30 is a view illustrating a case in which the data interpretation part of the speech intention expression system according to the second embodiment of the present invention grasps specific words.

As illustrated in FIG. 30, the oral tongue sensor 110, the facial sensors 120, the voice acquisition sensor 130, the vocal cord sensor 140, and the teeth sensor 150 measure specific consonants and vowels spoken by a speaker, and the data interpretation part 200 grasps the consonants and vowels as the articulatory features 220. [b], [i], and [f] which are the articulatory features 220 of the spoken consonants and vowels each correspond to the consonant-and-vowel phoneme unit index 361 of the database part 350, and the data interpretation part grasps [b], [i], and [f] as a word, /beef/ or [bif].

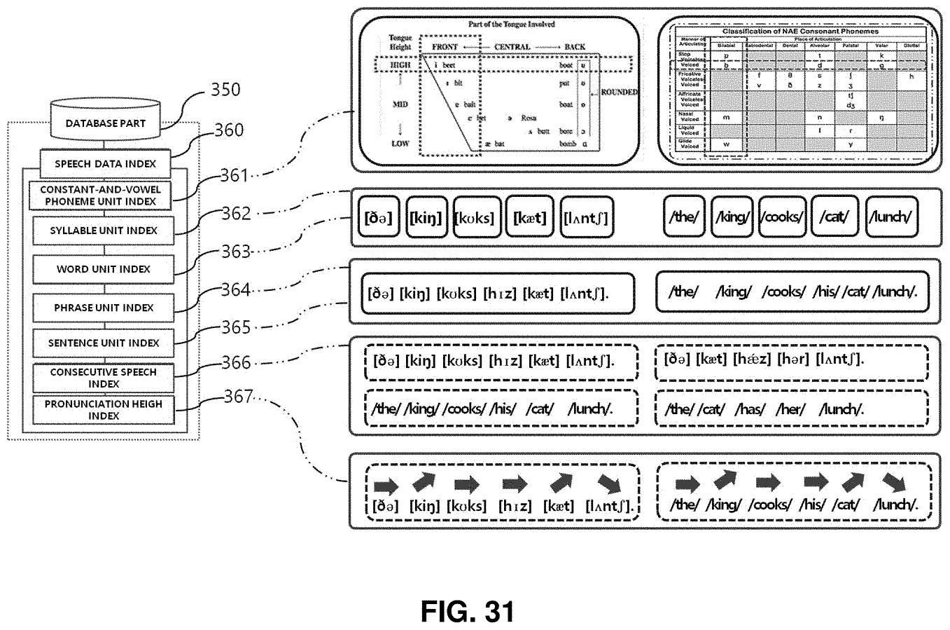

FIG. 31 is a view illustrating the database part of the speech intention expression system according to the second embodiment of the present invention.

As illustrated in FIG. 31, the speech data indices 360 of the database part 350 includes a consonant-and-vowel phoneme unit index 361, a syllable unit index 362, a word unit index 363, a phrase unit index 364, a sentence unit index 365, a consecutive speech index 366, and a pronunciation height index 367.

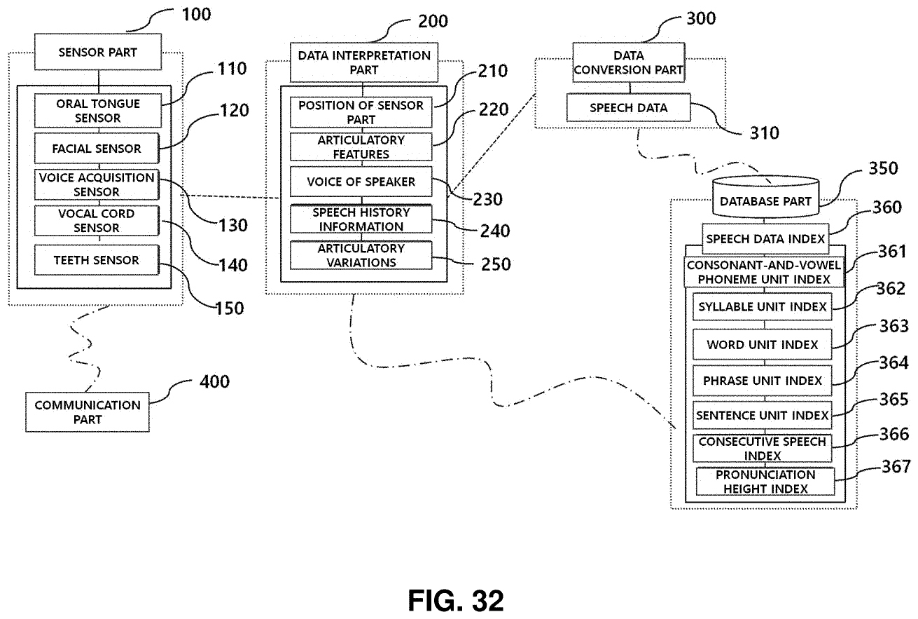

FIG. 32 is a view illustrating a speech intention expression system according to a third embodiment of the present invention.

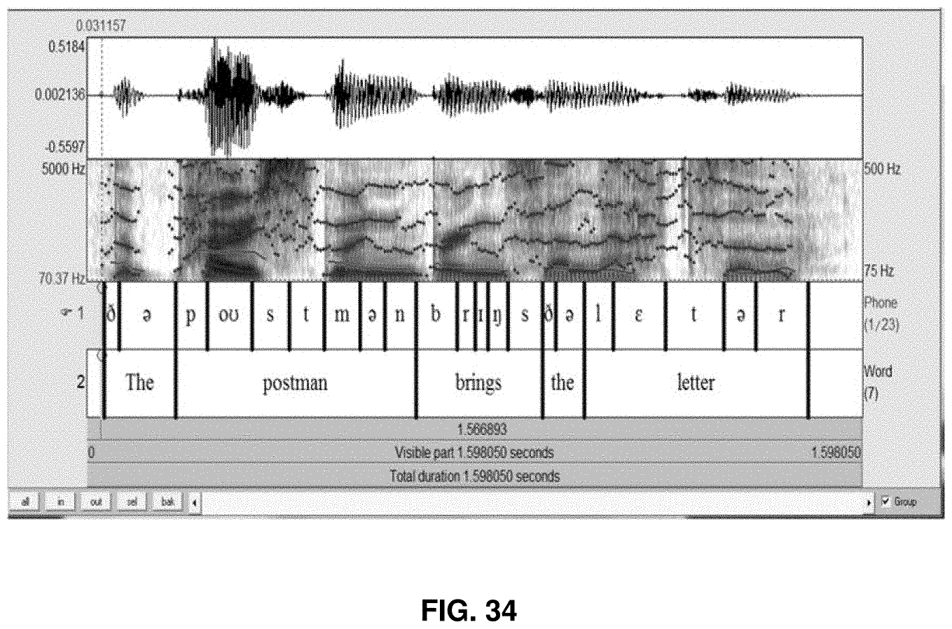

As illustrated in FIG. 32, the speech intention expression system includes a communication part 400 which is capable of, when one or more of the data interpretation part 200 and a data expression part 500 (see FIG. 34) operate while being disposed outside, communicating in linkage with the data interpretation part 200 and the data expression part 500. The communication part 400 may be implemented in a wired or wireless manner, and, in the case of the wireless communication part 400, various methods such as Bluetooth, Wi-Fi, third generation (3G) communication, fourth generation (4G) communication, and near-field communication (NFC) may be used.

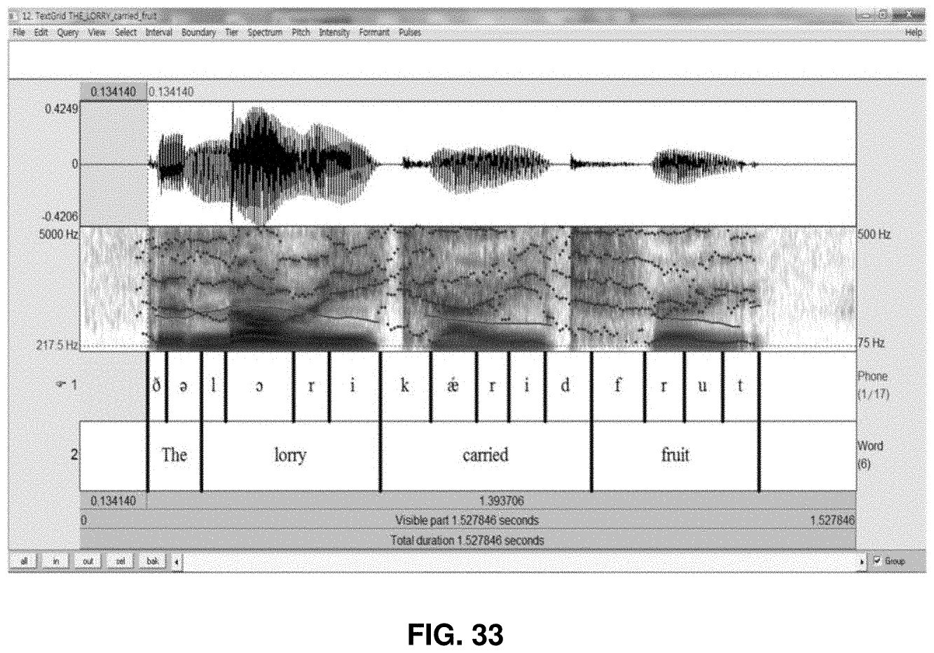

FIGS. 33 and 34 are views illustrating actual forms of a database part of the speech intention expression system according to the third embodiment of the present invention.

As illustrated in FIGS. 33 and 34, the database part 350 linked to the data interpretation part 200 grasps the articulatory features 220, the speaker's voice 230, the speech history information 240, and the articulatory variations 250 according to the actual speech as the speech data 310 by using the speech data indices.

FIG. 33 shows the actual data of the database part 350 obtained by the sensor part 100 measuring articulatory features of various consonants and vowels including the high front tense vowel and high back tense vowel of FIG. 23, the alveolar sounds of FIG. 24, and the voiceless labiodental fricatives of FIG. 27 and the data interpretation part 200 reflecting the measured articulatory features.

FIG. 34 shows the actual data of the database part 350 obtained by the sensor part 100 measuring articulatory features of various consonants and vowels including the high front lax vowel of FIG. 23, the alveolar sounds of FIG. 24, and the bilabial stop sounds of FIG. 25 and the data interpretation part 200 reflecting the measured articulatory features.

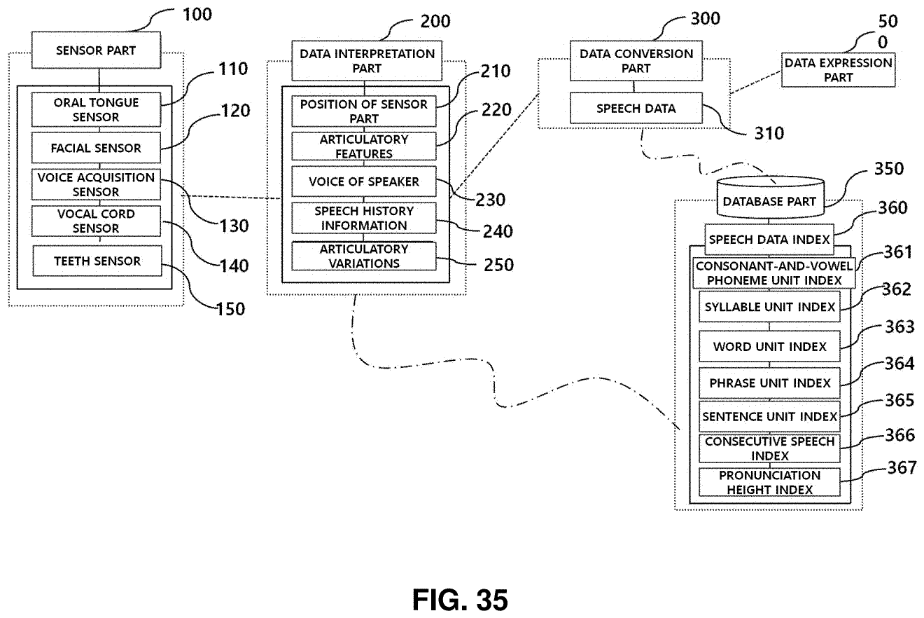

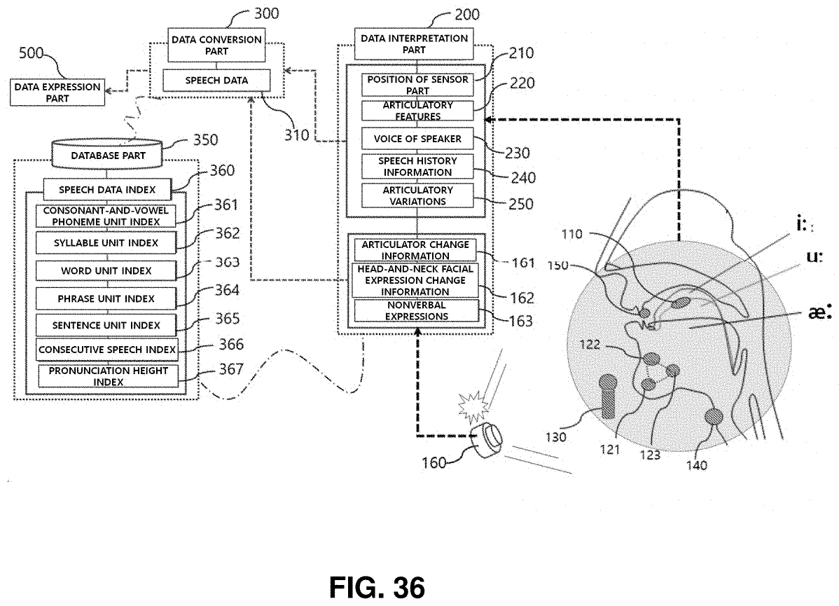

FIG. 35 is a view illustrating a speech intention expression system according to a fourth embodiment of the present invention, and FIG. 36 is a view illustrating linkage among a sensor part, a data interpretation part, a data expression part, and a database part of the speech intention expression system according to the fourth embodiment of the present invention.

As illustrated in FIG. 35, the speech intention expression system according to the fourth embodiment of the present invention includes a sensor part 100, a data interpretation part 200, a data conversion part 300, a database part 350, and a data expression part 500 which operate in organic linkage with each other.

As illustrated in FIG. 36, the sensor part 100 is disposed at the actual articulators and measures physical characteristics of the articulators according to a speaker's speech and transmits the measured physical characteristics to the data interpretation part 200, and the data interpretation part 200 interprets the received physical characteristics as speech data. The interpreted speech data is transmitted to the data expression part 500. It can be seen that the database part 350 operates in linkage with the data interpretation part 200 and the data expression part 500 in the interpretation and expression processes for the speech data.

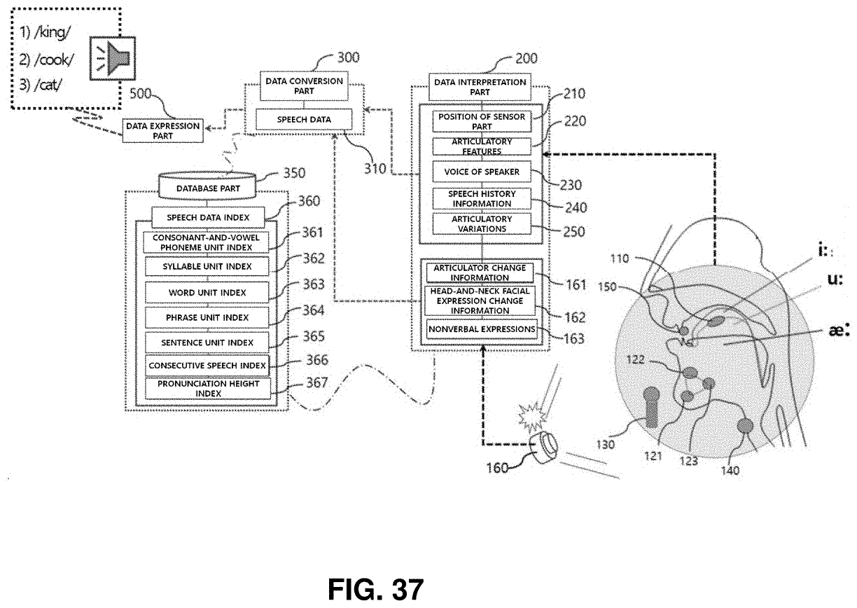

FIGS. 37 to 41 are views illustrating means by which the data expression part of the speech intention expression system according to the fourth embodiment of the present invention expresses speech data.

As illustrated in FIGS. 37 to 41, the physical characteristics of the head and neck articulators of the speaker which are obtained by the sensor part 100 are grasped by the data interpretation part 200 as the sensor part position 210, the articulatory features 220, the speaker's voice 230, the speech history information 240, and the articulatory variations 250.

The imaging sensor 160 images external changes in the head and neck articulators of the speaker, and, in this way, the data interpretation part 200 grasps the head-and-neck articulator change information 161 and the head-and-neck facial expression change information 162.

Then, the pieces of information are converted to the speech data 310 by the data interpretation part 200 and are expressed to the outside by the data expression part 500.

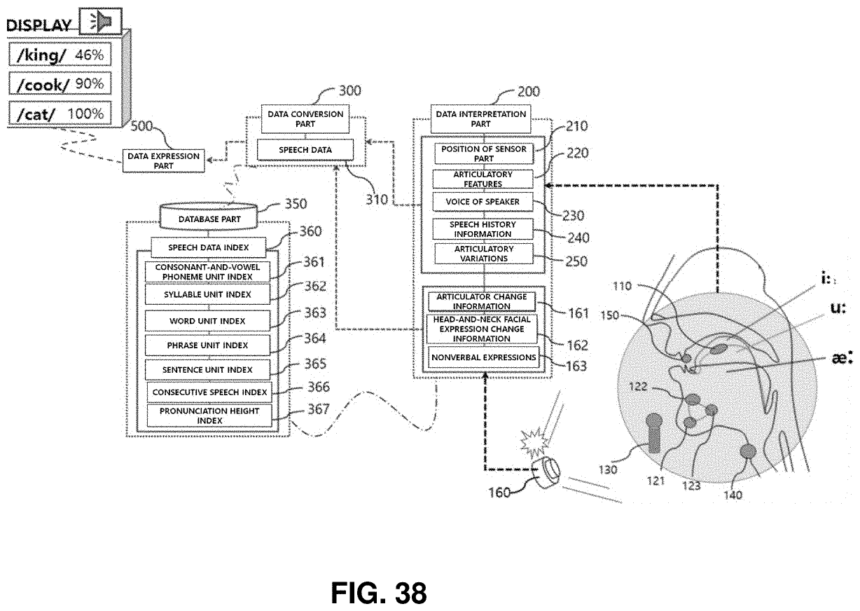

In this case, FIG. 37 shows a case in which the data expression part 500 aurally expresses the speech data 310, and FIG. 38 shows a case in which, in visually expressing the speech data 310, the data expression part 500 compares the speech data indices 360 of the database part 350 with the physical characteristics of the articulators of the speaker measured by the data interpretation part 200 and provides, together with broad description of the actual standard pronunciation, one or more measured numerical values among the degree of rightness/wrongness of stress, the degree of similarity/contiguity, and the intention of speech.

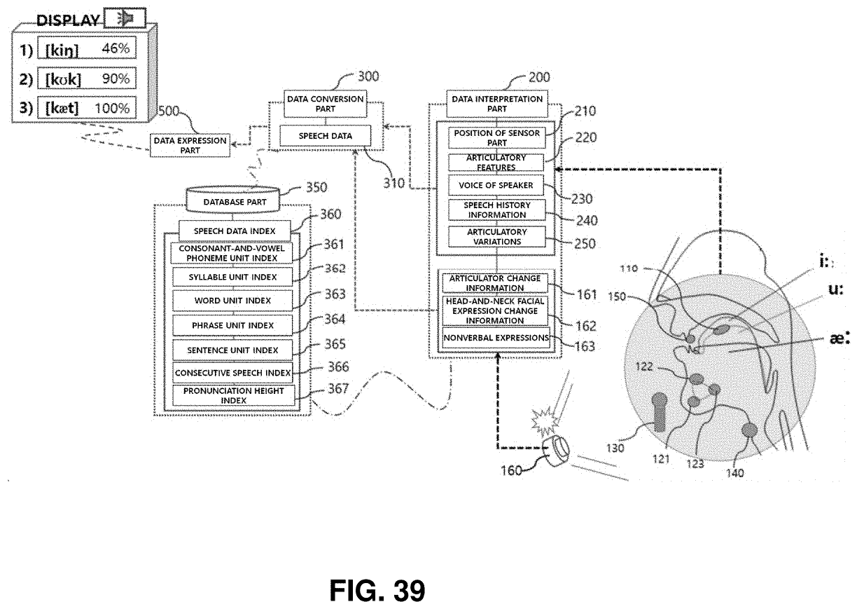

FIG. 39 shows a case in which, in visually and aurally expressing the speech data 310, the data expression part 500 compares the speech data indices 360 of the database part 350 with the physical characteristics of the articulators of the speaker measured by the data interpretation part 200 and provides, together with narrow description of the actual standard pronunciation, one or more measured numerical values among the degree of rightness/wrongness of stress, the degree of similarity/contiguity, and the intention of speech.

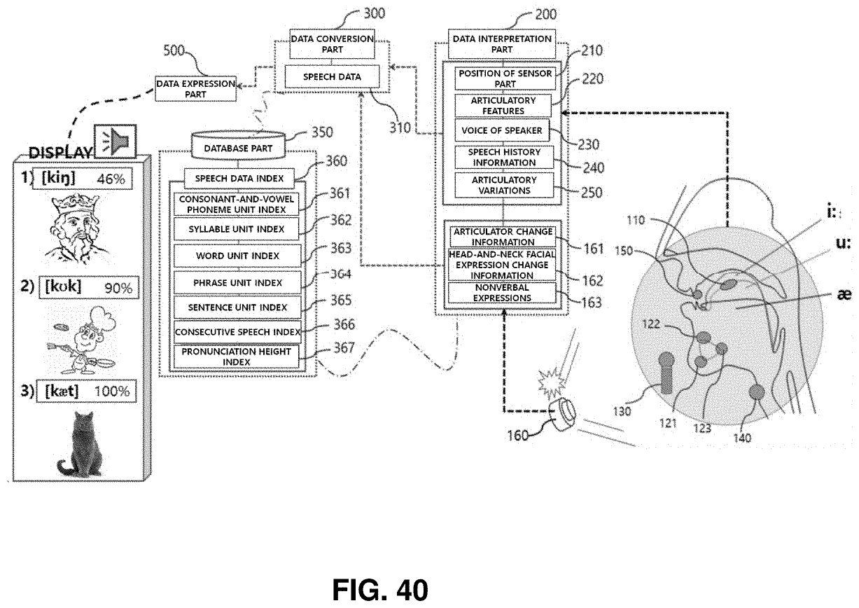

FIG. 40 shows a case in which, in visually expressing the speech data 310, the data expression part 500 compares the speech data indices 360 of the database part 350 with the physical characteristics of the articulators of the speaker measured by the data interpretation part 200 and provides, together with narrow description of the actual standard pronunciation, one or more measured numerical values among the degree of rightness/wrongness of stress, the degree of similarity/contiguity, and the intention of speech and, when the corresponding speech data 310 is a word and corresponds to the word unit index 363, an image corresponding thereto.

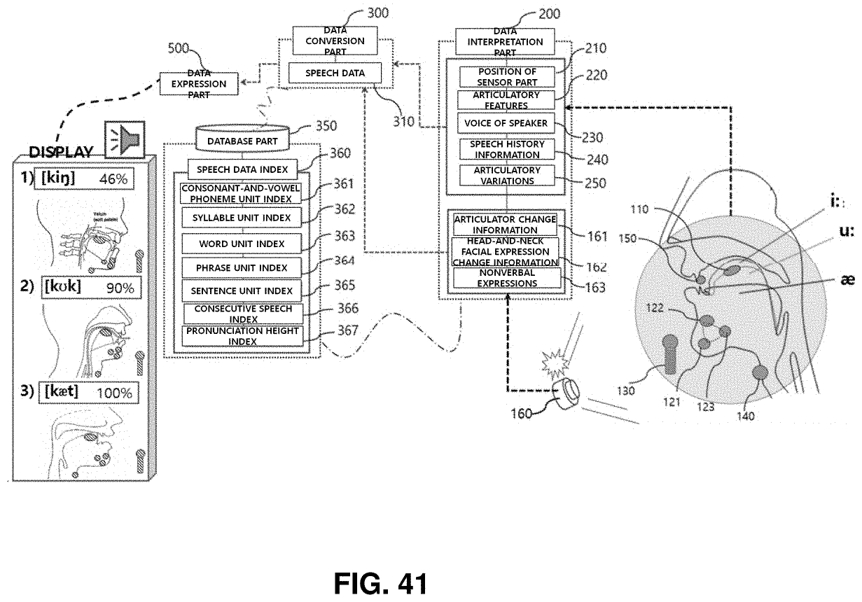

FIG. 41 shows a case in which, in visually and aurally expressing the speech data 310, the data expression part 500 compares the speech data indices 360 of the database part 350 with the physical characteristics of the articulators of the speaker measured by the data interpretation part 200 and provides, together with narrow description of the actual standard pronunciation, one or more measured numerical values among the degree of rightness/wrongness of stress, the degree of similarity/contiguity, and the intention of speech, and a speech correction image capable of speaking the corresponding pronunciation so that the speech data 310 by the speaker may be corrected and enhanced.

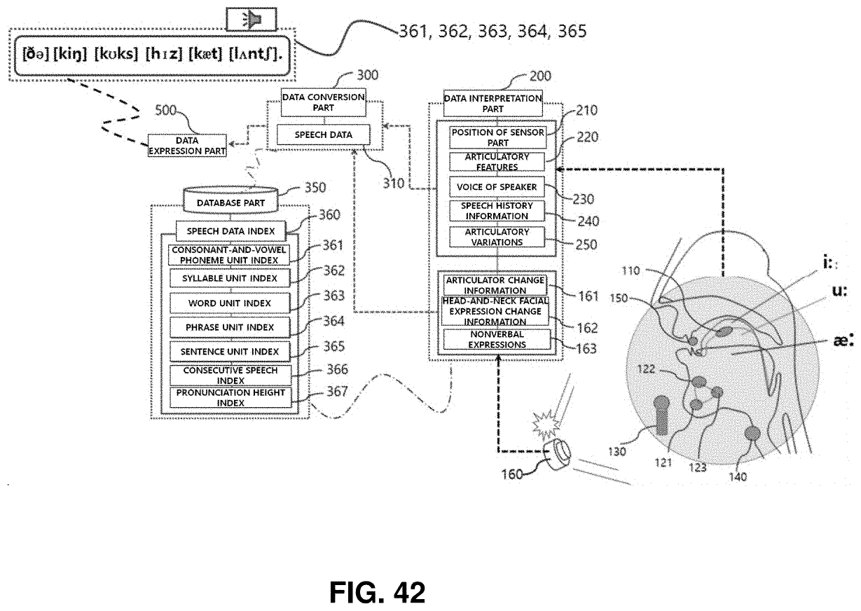

FIG. 42 is a view illustrating a case in which the data expression part of the speech intention expression system according to the fourth embodiment of the present invention visually and aurally expresses speech data.

As illustrated in FIG. 42, in providing the speech data 310 by visualizing the speech data 310 in text and auralizing the speech data 310 as sounds, the data expression part 500 compares the physical characteristics of the articulators of the speaker measured by the data interpretation part 200 with one or more speech data indices 360 among the consonant-and-vowel phoneme unit index 361, the syllable unit index 362, the word unit index 363, the phrase unit index 364, and the sentence unit index 365 of the database part 350.

The data expression part 500 provides, together with narrow description of the actual standard pronunciation related to the speech data 310 of the speaker, the speech data 310 and one or more measured numerical values among the rightness/wrongness of stress, the degree of similarity/contiguity, and the intention of speech in text and sound, thereby helping the speaker with correcting and enhancing the speech data 310.

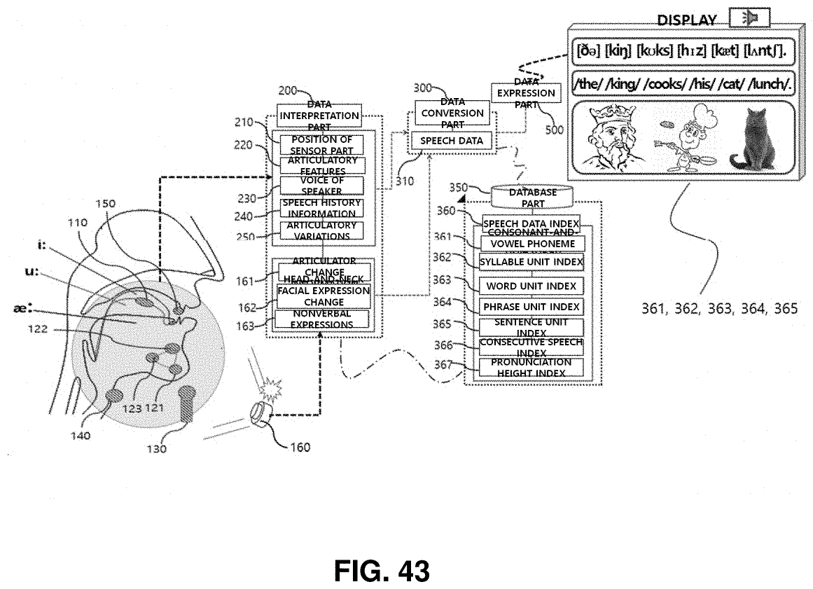

FIG. 43 is a view illustrating a case in which the data expression part of the speech intention expression system according to the fourth embodiment of the present invention visually expresses speech data.

As illustrated in FIG. 43, the data expression part 500 provides the speech data 310 by visualizing the speech data 310 in one or more of text, a figure, a picture, and an image.

In this case, the data interpretation part 200 compares the measured physical characteristics of the articulators of the speaker with one or more speech data indices 360 among the of the consonant-and-vowel phoneme unit index 361, the syllable unit index 362, the word unit index 363, the phrase unit index 364, and the sentence unit index 365 of the database part 350.

Further, when the speech data 310 is visualized in text, the data expression part 500 provides both the narrow description and broad description of the actual standard pronunciation. In this way, the data expression part 500 provides, together with narrow description and broad description of the actual standard pronunciation related to the speech data 310 of the speaker, the speech data 310 and one or more measured numerical values among the rightness/wrongness of stress, the degree of similarity/contiguity, and the intention of speech in text and sound, thereby helping the speaker with correcting and enhancing the speech data 310.

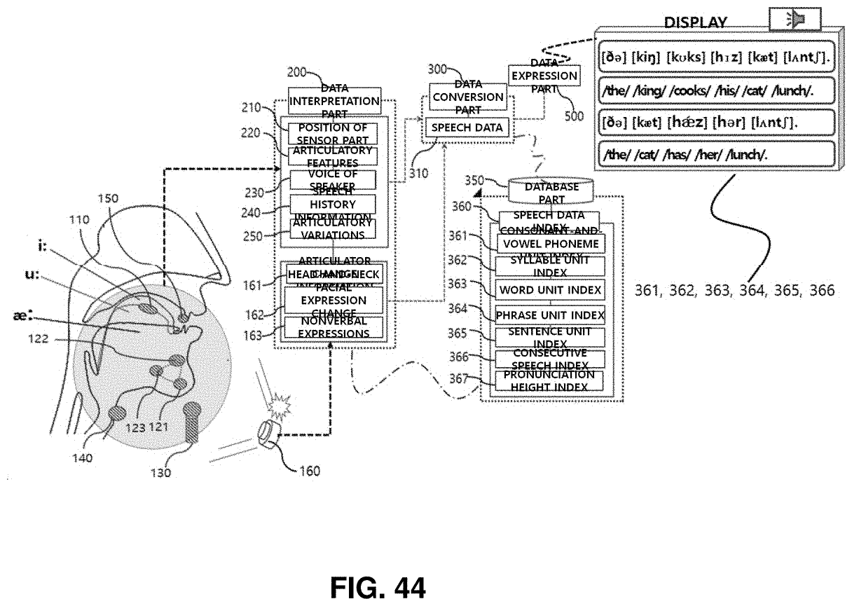

FIG. 44 is a view illustrating a case in which the data expression part of the speech intention expression system according to the fourth embodiment of the present invention visually expresses speech data.

As illustrated in FIG. 44, in providing the speech data 310 by visualizing the speech data 310 in text, the data expression part 500 compares the physical characteristics of the articulators of the speaker measured by the data interpretation part 200 with one or more speech data indices 360 among the consonant-and-vowel phoneme unit index 361, the syllable unit index 362, the word unit index 363, the phrase unit index 364, the sentence unit index 365, and the consecutive speech index 366 of the database part 350. The data expression part 500 provides, together with narrow description and broad description of the actual standard pronunciation related to the speech data 310 of the speaker, the speech data 310 and one or more measured numerical values among the rightness/wrongness of stress, the degree of similarity/contiguity, and the intention of speech in text and sound in consecutive speech units, thereby helping the speaker with correcting and enhancing the speech data 310.

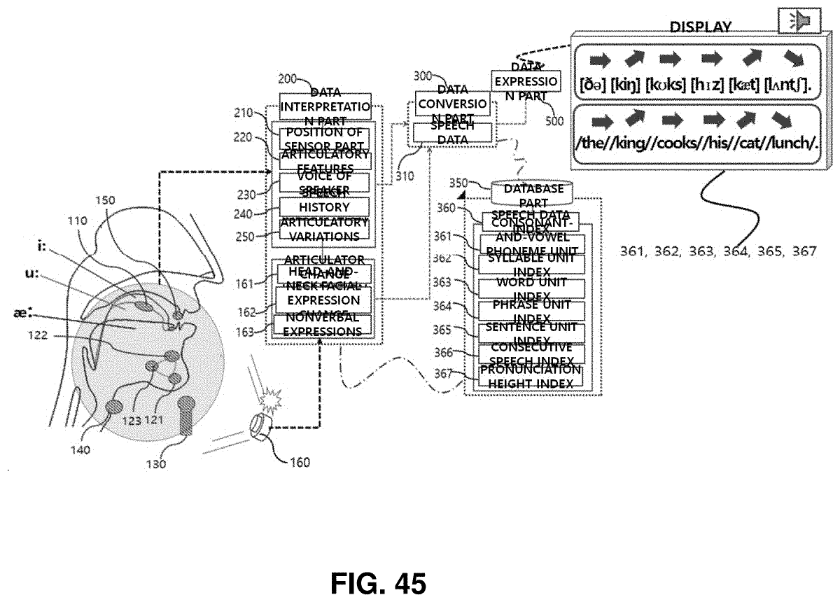

FIG. 45 is a view illustrating a case in which the data expression part of the speech intention expression system according to the fourth embodiment of the present invention expresses speech data in consecutive speech units.

As illustrated in FIG. 45, in providing the speech data 310 by visualizing the speech data 310 in text and auralizing the speech data 310 as sounds, the data expression part 500 compares the physical characteristics of the articulators of the speaker measured by the data interpretation part 200 with one or more speech data indices 360 among the consonant-and-vowel phoneme unit index 361, the syllable unit index 362, the word unit index 363, the phrase unit index 364, the sentence unit index 365, the consecutive speech index 366, and the pronunciation height index 367 of the database part 350. The data expression part 500 provides, together with narrow description and broad description of the actual standard pronunciation related to the speech data 310 of the speaker, the speech data 310 and one or more measured numerical values among the rightness/wrongness of stress, the degree of similarity/contiguity, and the intention of speech in text and sound, thereby helping the speaker with correcting and enhancing the speech data 310.

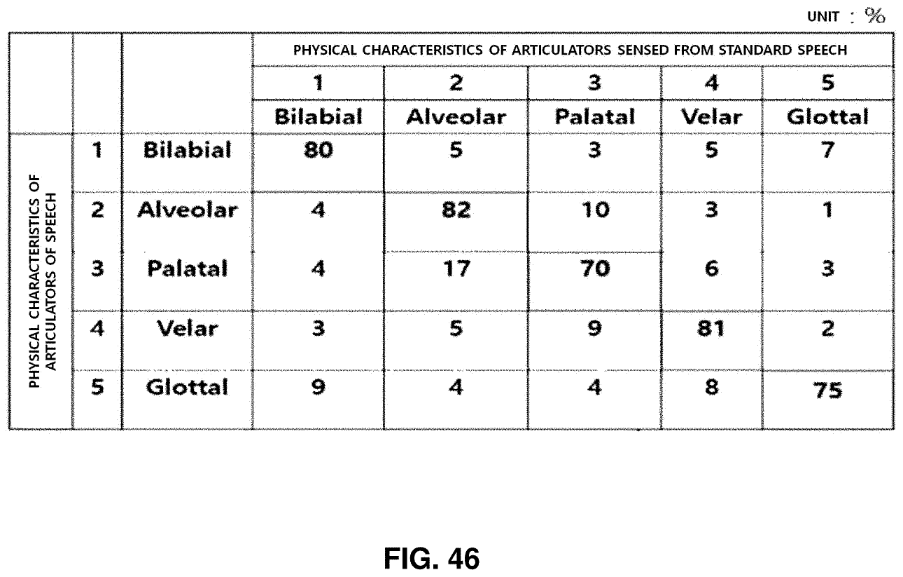

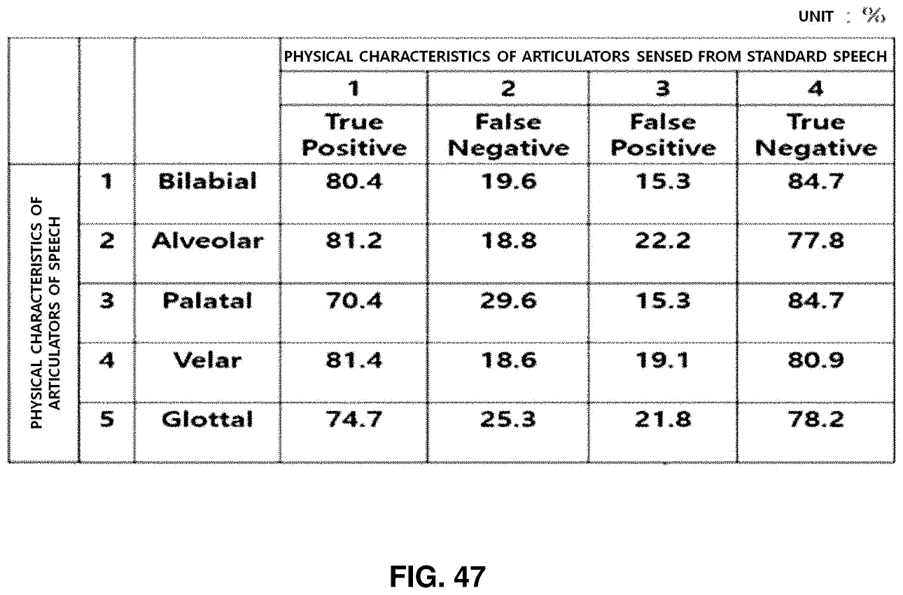

FIG. 46 is a view illustrating a confusion matrix utilized by the speech intention expression system according to the fourth embodiment of the present invention, and FIG. 47 is a view illustrating the confusion matrix, which is utilized by the speech intention expression system according to the fourth embodiment of the present invention, shown in percentage.

As illustrated in FIGS. 46 and 47, in grasping the speech data 310, the data interpretation part 200 typically uses one or more feature extraction algorithms using a time-domain variance, a cepstral coefficient of a frequency domain, and a linear predict coding coefficient.

The variance which represents the degree of distribution of data is calculated according to the following [Equation 1]. Here, n represents a population network, x̅ represents a population average of pieces of data which are collected physical characteristics of articulators, and xᵢ represents the pieces of data which are the collected physical characteristics of the articulators.

$${s}^{2} = \frac{1}{n - 1} {\sum }_{i = 1}^{N} {( {x}_{i} - \overline{x} )}^{2} \qquad [ Equation 1 ]$$

The cepstral coefficient is calculated by the following [Equation 2] in order to standardize the intensity of a frequency. Here, F⁻¹ represents inverse Fourier transform, and X(f) represents a frequency spectrum of a signal. In the present example, a value when n=0 was utilized as the cepstral coefficient.

Cₙ=F⁻¹ log|X(f)| [Equation 2]

The linear predict coding coefficient represents a linear characteristic of a frequency and is calculated according to the following [Equation 3]. Here, n represents the number of samples, and aᵢ represents the linear predict coding coefficient. A value when n=1 was utilized as the cepstral coefficient.

$${C}_{n} = - {a}_{n} - \frac{1}{n} {\sum }_{i = 1}^{n - 1} ( n - i ) {a}_{i} {c}_{n - i} \qquad [ Equation 3 ]$$

Further, the ANN in which pieces of data, which are physical characteristics of articulators, are grouped according to the degree of similarity and prediction data is generated to classify the pieces of data was utilized. In this way, the speaker may grasp the degree of rightness/wrongness, degree of contiguity/similarity, and intention of speech regarding the initial speech of the speaker himself/herself, as compared with the standard speech. On the basis of the grasped degree of rightness/wrongness, degree of contiguity/similarity, and intention of speech, the speaker obtains feedback regarding his or her speech and continuously re-performs the speech for speech correction. By the method of repetitively inputting pieces of data on physical characteristics of articulators, the pieces of data on the physical characteristics of the articulators are gathered, and accuracy of the ANN is improved.

Here, ten consonants were selected as the physical characteristics of the articulators, which are pieces of input data, and the pieces of input data were classified as bilabial, alveolar, palatal, velar, and glottal, which are five places of articulation, in the feature extraction process. To this end, the ten consonants corresponding to the five places of articulation were sequentially pronounced hundred times each, i.e., a total of thousand times, and randomly pronounced fifty times each, i.e., a total of five-hundred times.

Accordingly, the confusion matrix for consonant classification was formed as illustrated in FIG. 46. On the basis of the confusion matrix, by taking into consideration that the number of spoken consonants is different for each place of articulation, the confusion matrix was shown in percentage as illustrated in FIG. 47.

In this way, the speaker may recognize that, regarding palatals whose pronunciation involves low degree of rightness/wrongness and low degree of contiguity/similarity as compared with the standard speech, consonants are not properly spoken. Also, as illustrated in FIG. 46, the case in which a speaker attempted to speak a consonant associated with a palatal but speaks a consonant related to an alveolar by mistake accounts for 17%. This indicates that the speaker does not clearly recognize the difference between consonants related to a palatal and consonants related to an alveolar.

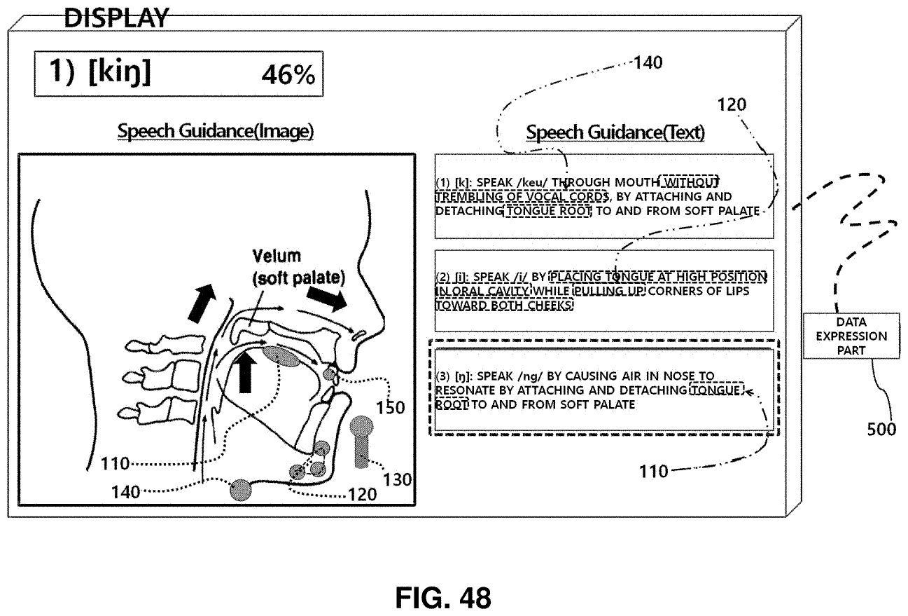

FIG. 48 is a view illustrating a case in which the speech intention expression system according to the fourth embodiment of the present invention helps a speaker with speech correction and guidance through a screen.

As illustrated in FIG. 48, a Korean speaker whose native language is not English spoke while attempting to pronounce [ki [symbol] ], and the sensor part 100 grasped physical characteristics of articulators according to the speech.

However, the speaker was not familiar with articulation and speech methods related to [ [symbol] ] rework which is a velar nasal sound that does not exist in Korean.

Thus, the data interpretation part 200 grasped [ [symbol] ], which was not properly pronounced by the speaker, through a comparison with the standard articulatory feature matrix 205. Then, the data expression part 300 provided the degree of rightness/wrongness and degree of similarity of the speech of the speaker, which were only 46%. Then, the data expression part 300 helps the speaker with accurately pronouncing [ki [symbol] ] rework through a screen or the like.

In this case, the data expression part 300 provides speech guidance (image) in order to intuitively show the speaker how the speaker should manipulate which articulators. The speech guidance (image) proposed by the data expression part 300 performs speech correction and guidance on the basis of a sensor part which is attached to or adjacent to articulators for pronouncing the [ [symbol] ]. rework For example, in the case of the [ki [symbol] ], in order to pronounce [k], the speaker should speak / [symbol] (keu)/ through the mouth by producing a plosive sound by raising the tongue body or tongue root toward the soft palate and attaching and detaching the tongue body or tongue root to and from the soft palate and producing a voiceless sound without trembling of the vocal cords.

In this case, the oral tongue sensor 110 measures the plosive sound produced by the tongue body or tongue root being raised toward the soft palate and being attached and detached to and from the soft palate. In the case of since is a high front tense vowel, the oral tongue sensor 110 grasps the high tongue height and tongue frontness regarding the vowel [i]. Further, when pronouncing [i], a phenomenon in which the corners of the lips are pulled toward both cheeks occurs. The occurrence of the phenomenon is grasped by the facial sensors 120. In the case of [ [symbol] ], rework in order to pronounce [ [symbol] ], the tongue body or tongue root should be raised toward the soft palate and the air in the nose should be caused to resonate. Thus, even in this case, the oral tongue sensor 110 grasps the height and frontness/backness of the tongue.

Further, since the pronunciation of [ [symbol] ] rework is a nasal sound, the nose and the muscles surrounding the nose tremble. The phenomenon may be grasped by the facial sensors 120 attached around the nose.

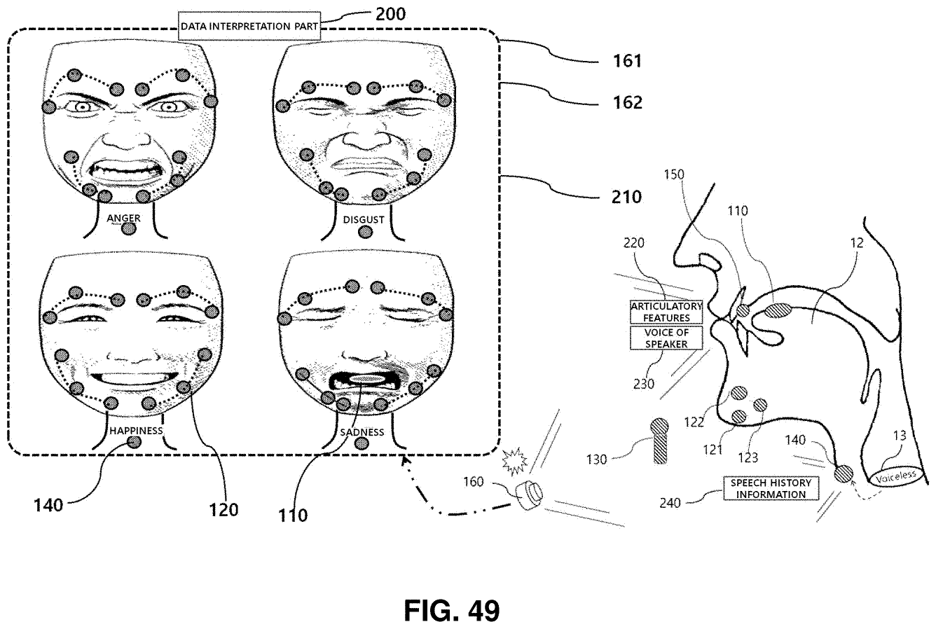

FIG. 49 is a view illustrating a case in which the speech intention expression system according to the fourth embodiment of the present invention images and grasps the exterior of the head and neck articulators.

As illustrated in FIG. 49, the imaging sensor 160 images external changes in the head and neck articulators of the speaker according to speech, and, in this way, the data interpretation part 200 grasps the head-and-neck articulator change information 161 and the head-and-neck facial expression change information 162 of the speaker. In this case, the data interpretation part 200 also takes into consideration the articulatory features 210 of the speaker which have been grasped by the oral tongue sensor 110, the facial sensors 120, the voice acquisition sensor 130, the vocal cord sensor 140, and the teeth sensor 150 of the sensor part 100.

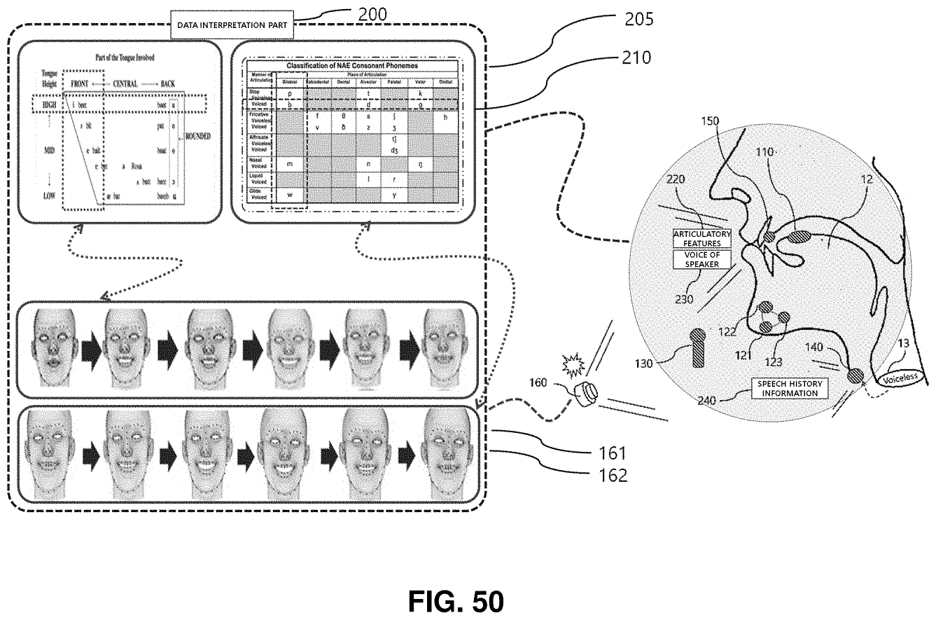

FIG. 50 is a view illustrating a case in which the speech intention expression system according to the fourth embodiment of the present invention combines mutual pieces of information through a standard articulatory feature matrix.

As illustrated in FIG. 50, the oral tongue sensor 110, the facial sensors 120, the voice acquisition sensor 130, the vocal cord sensor 140, and the teeth sensor 150 of the sensor part 100 grasp the articulatory features 210 of the speaker, and the imaging sensor 160 grasps the head-and-neck articulator change information 161 and the head-and-neck facial expression change information 162 of the speaker. In this way, the data interpretation part 200 combines articulatory features corresponding to the head-and-neck articulator change information 161 and the head-and-neck facial expression change information 162 of the speaker on the basis of the standard articulatory feature matrix 205.

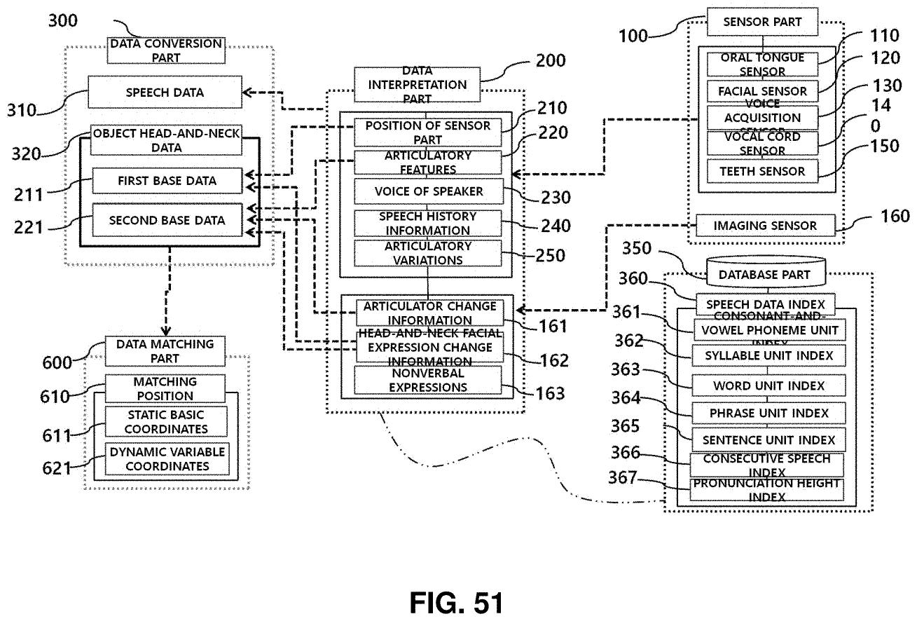

FIG. 51 is a view illustrating a speech intention expression system according to a fifth embodiment of the present invention.

As illustrated in FIG. 51, on the basis of the sensor part position 210 measured by the sensor part 100 and the head-and-neck facial expression change information 162 obtained by the imaging sensor 160, the data conversion part 300 generates first base data 211 of object head-and-neck data 320. A data matching part 600 performs matching by generating static basic coordinates 611 at matching positions 610, where the object head-and-neck data may be matched, of one or more objects 20 of an image object's head-and-neck 21 and a robot object's head-and-neck 22.

Further, on the basis of the articulatory features 220 of the speaker 10 measured by the sensor part 100 and the articulator change information 161 and the head-and-neck facial expression change information 162 which are obtained by the imaging sensor 160, the data conversion part 300 generates second base data 221 of the object head-and-neck data 320. The data matching part 600 performs matching by generating dynamic variable coordinates 621 in order to implement dynamic movement of the head and neck, which changes as the one or more objects 20 of the image object's head-and-neck 21 and the robot object's head-and-neck 22 speaks, on the basis of the second base data 221.

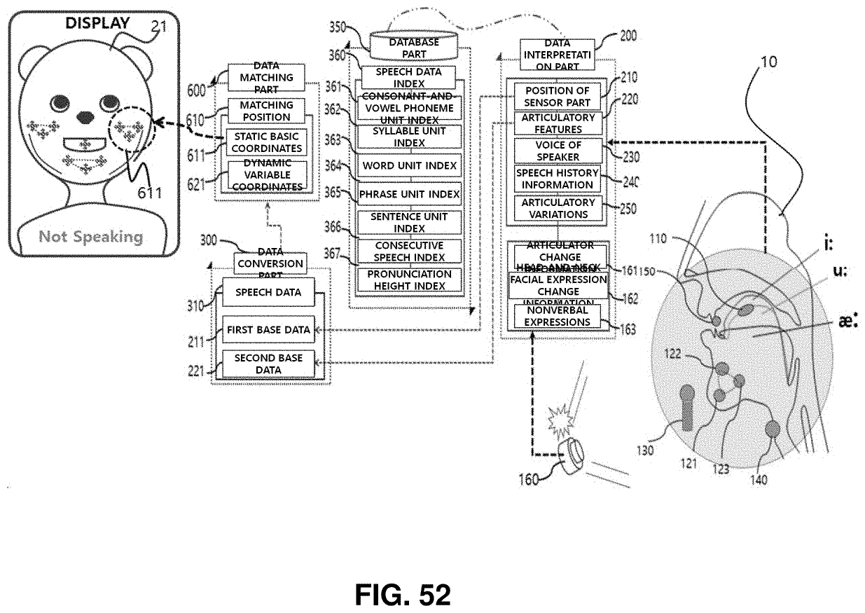

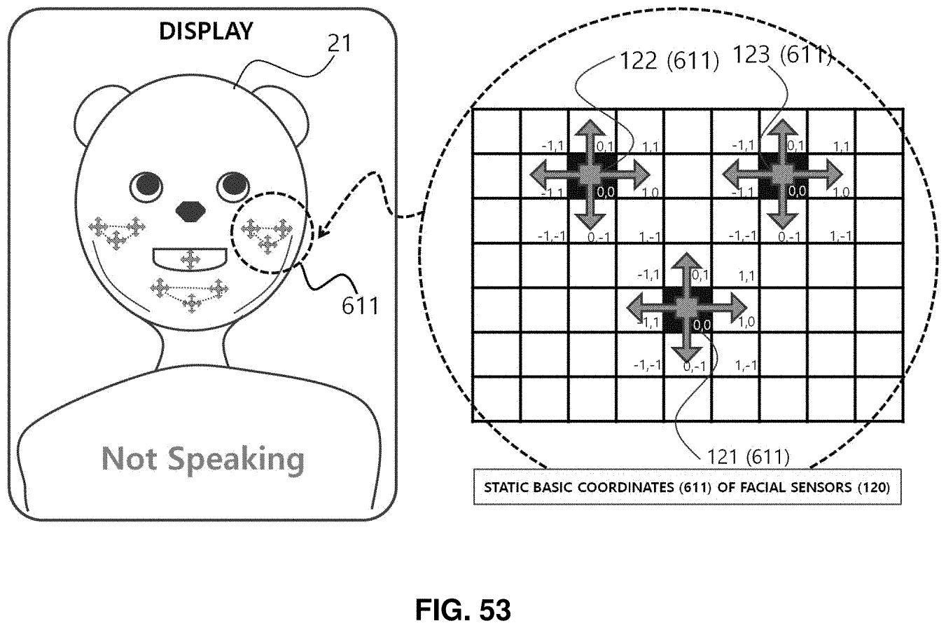

FIG. 52 is a view illustrating a case in which the speech intention expression system according to the fifth embodiment of the present invention matches object head-and-neck data to the head and neck of an image object on the basis of static basic coordinates, and FIG. 53 is a view illustrating static basic coordinates based on positions of facial sensors utilized by the speech intention expression system according to the fifth embodiment of the present invention.

As illustrated in FIGS. 52 and 53, in order to match the object head-and-neck data 320 to the image object's head-and-neck 21, the data matching part 600 generates the static basic coordinates 611 by utilizing the first base data 211 which indicates positions of the facial sensors 120 attached to the speaker's head and neck.

In this case, as described above, the facial sensors 120 grasp the positions thereof by utilizing potential differences among the facial sensors 120. The reference sensor 121, the positive electrode sensor 122, and the negative electrode sensor 123 among the facial sensors 120 attached while the speaker does not speak each have reference positions, e.g., coordinates (0, 0). Such positions become the static basic coordinates 611.

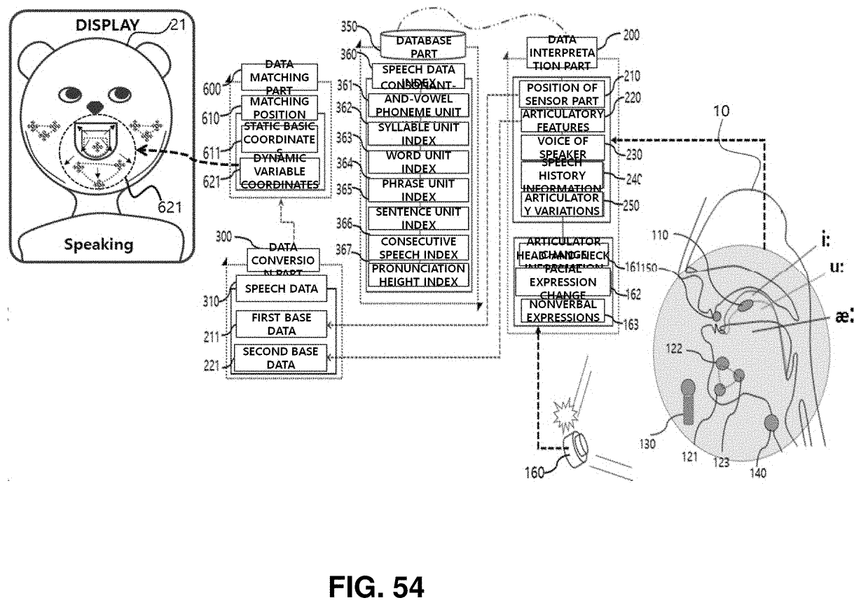

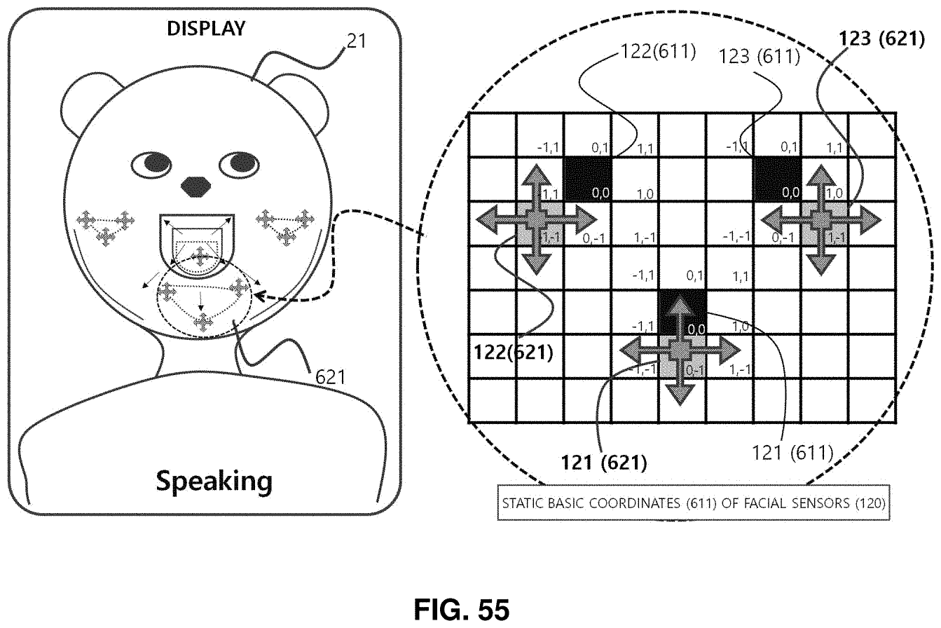

FIG. 54 is a view illustrating a case in which the speech intention expression system according to the fifth embodiment of the present invention matches object head-and-neck data to the head and neck of an image object on the basis of dynamic variable coordinates, and FIG. 55 is a view illustrating dynamic variable coordinates based on voltage differences among facial sensors utilized by the speech intention expression system according to the fifth embodiment of the present invention.

As illustrated in FIGS. 54 and 55, in order to match the object head-and-neck data 320 to the image object's head-and-neck 21, the data matching part 600 is attached to the head and neck of the speaker and generates the dynamic variable coordinates 621 by utilizing the second base data 221, which indicates potential differences among the facial sensors 120 due to actions of the head-and-neck muscles according to speech of the speaker.

In this case, as described above, the facial sensors 120 measure an electromyogram of the head and neck which move according to the speech of the speaker to grasp physical characteristics of the head and neck articulators. The reference sensor 121, the positive electrode sensor 122, and the negative electrode sensor 123, which are the facial sensors 120, attached while the speaker speaks grasp the electromyogram of the head-and-neck muscles which changes according to speech such that the reference sensor 121, the positive electrode sensor 122, and the negative electrode sensor 123 each have variable positions, e.g., coordinates (0, −1), (−1, −1), and (1, −1). Such positions become the dynamic variable coordinates 621.

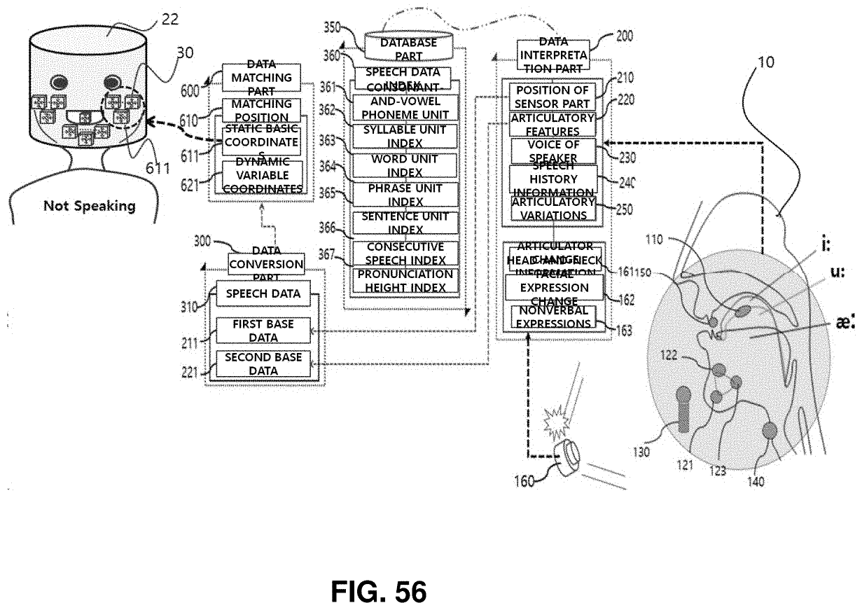

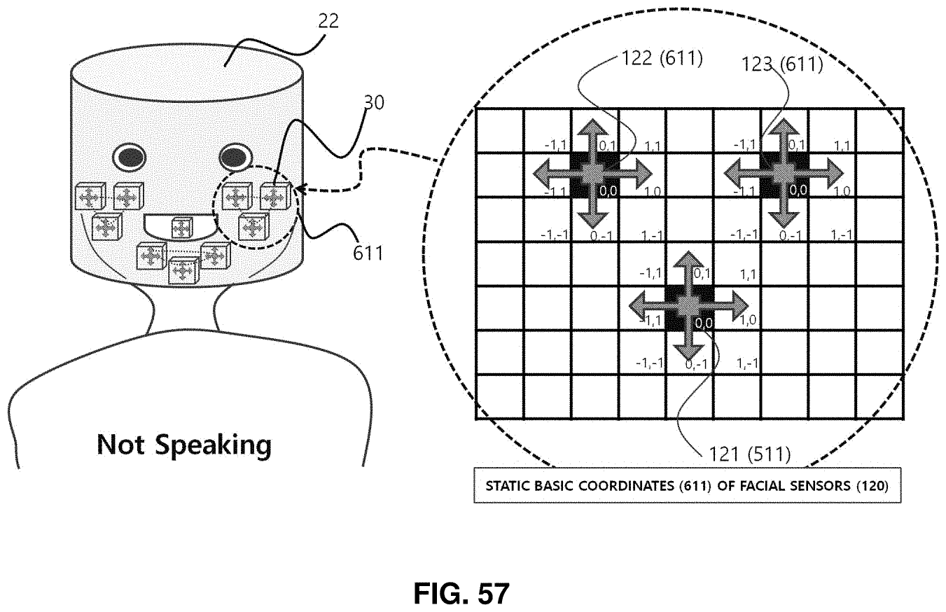

FIG. 56 is a view illustrating a case in which the speech intention expression system according to the fifth embodiment of the present invention matches object head-and-neck data to an actuator of the head and neck of a robot object on the basis of static basic coordinates, and FIG. 57 is a view illustrating the static basic coordinates based on the voltage differences among the facial sensors utilized by the speech intention expression system according to the fifth embodiment of the present invention.

As illustrated in FIGS. 56 and 57, in order to match the object head-and-neck data 320 to an actuator 30 of the robot object's head-and-neck 22, the data matching part 600 generates the static basic coordinates 611 by utilizing the first base data 211, which indicates positions of the facial sensors 120 attached to the speaker's head and neck.

In this case, as described above, the facial sensors 120 grasp the positions thereof by utilizing potential differences among the facial sensors 120. The reference sensor 121, the positive electrode sensor 122, and the negative electrode sensor 123 among the facial sensors 120 attached while the speaker does not speak each have reference positions, e.g., coordinates (0, 0), in the actuator 30 of the robot object's head-and-neck 22. Such positions become the static basic coordinates 611

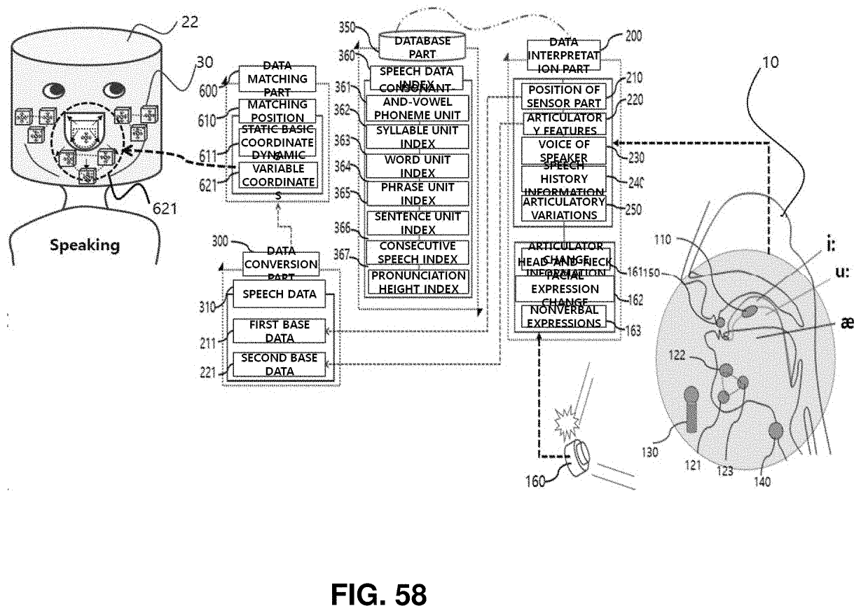

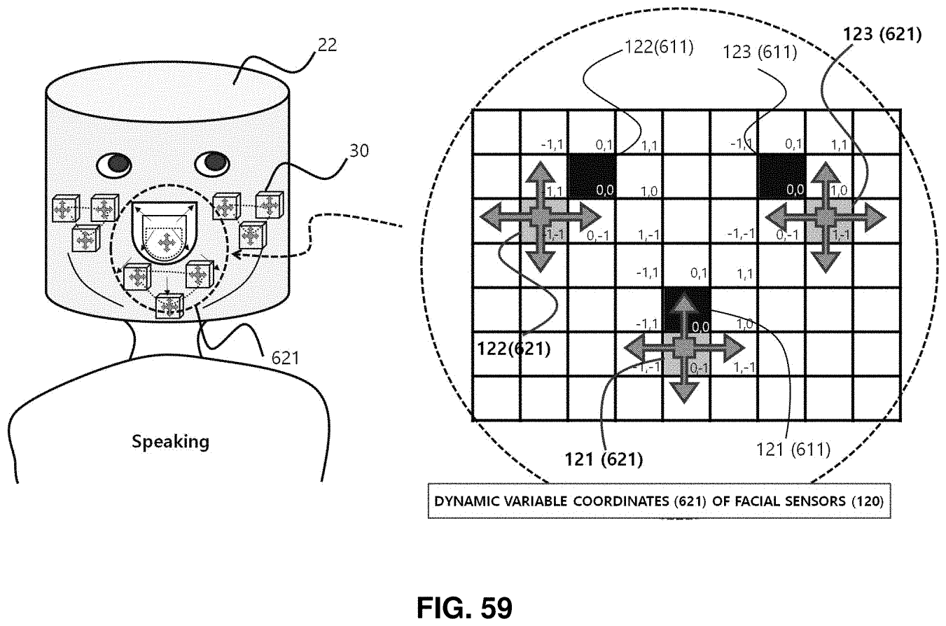

FIG. 58 is a view illustrating a case in which the speech intention expression system according to the fifth embodiment of the present invention matches object head-and-neck data to the actuator of the head and neck of the robot object on the basis of dynamic variable coordinates, and FIG. 59 is a view illustrating the dynamic variable coordinates based on the voltage differences among facial sensors utilized by the speech intention expression system according to the fifth embodiment of the present invention.

As illustrated in FIGS. 58 and 59, in order to match the object head-and-neck data 320 to the actuator 30 of the robot object's head-and-neck 22, the data matching part 600 is attached to the speaker's head and neck and generates the dynamic variable coordinates 621 by utilizing the second base data 221, which indicates potential differences among the facial sensors 120 due to actions of the head-and-neck muscles according to speech of the speaker.

In this case, as described above, the facial sensors 120 measure an electromyogram of the head and neck which move according to the speech of the speaker to grasp physical characteristics of the head and neck articulators. The reference sensor 121, the positive electrode sensor 122, and the negative electrode sensor 123, which are the facial sensors 120, attached while the speaker speaks grasp the electromyogram of the head-and-neck muscles which changes according to speech such that each actuator 30 has a variable position, e.g., the coordinates (0, −1), (−1, −1), and (1, −1), and moves according to the position. Such positions become the dynamic variable coordinates 621.

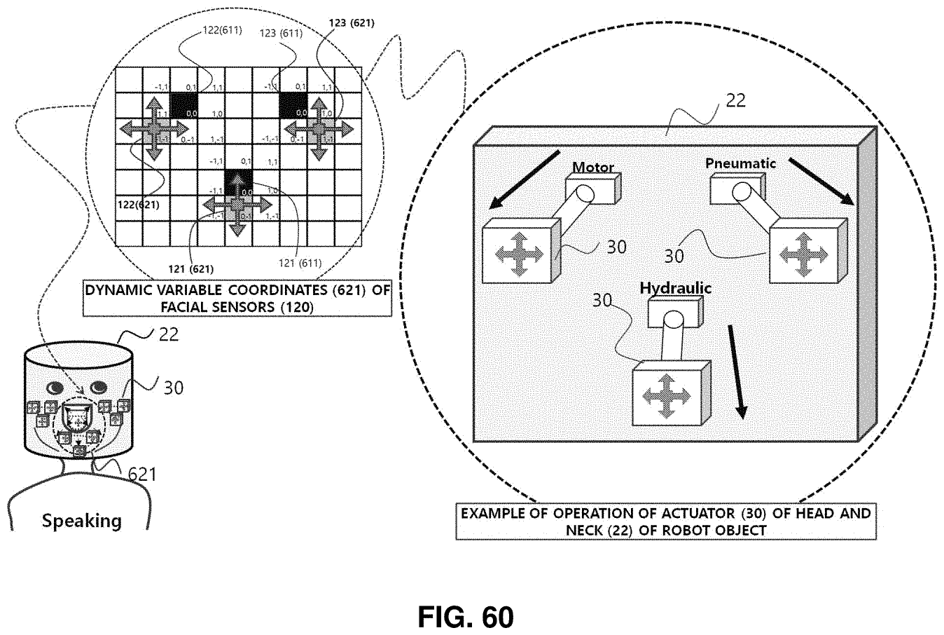

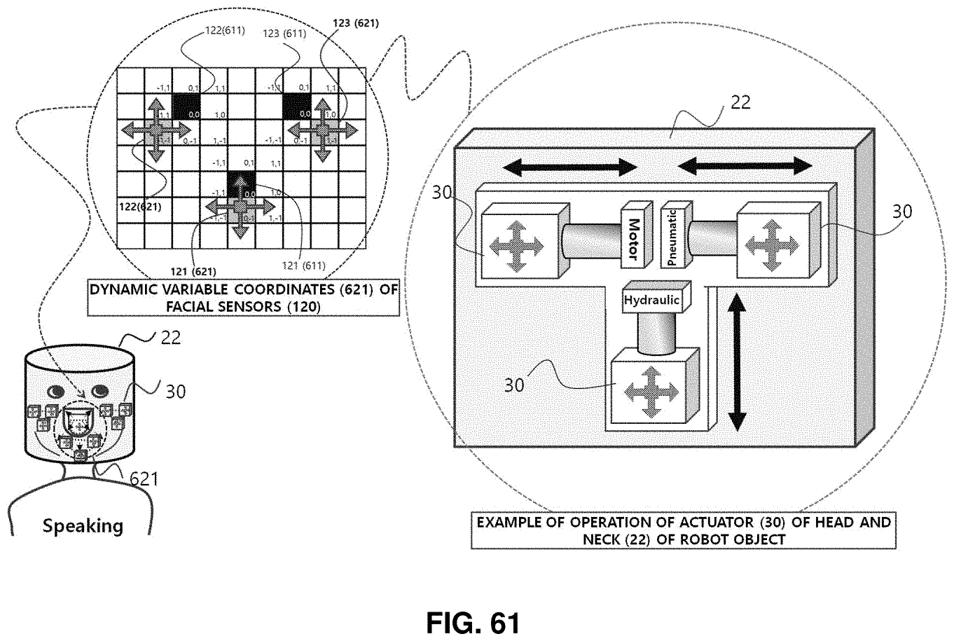

FIGS. 60 and 61 are views each illustrating an operation of the actuator of the head and neck of the robot object in the speech intention expression system according to the fifth embodiment of the present invention, and FIG. 62 is a view illustrating the actuator of the head and neck of the robot object in the speech intention expression system according to the fifth embodiment of the present invention.

As illustrated in FIG. 60, the data matching part 600 performs matching by transmitting the object head-and-neck data 310 obtained from the data interpretation part 200 and the data conversion part 300 to one or more actuators 30 of the robot object's head-and-neck 22. Accordingly, as artificial muscles and skeletons of the robot object's head-and-neck 22, the actuators 30 may be driven by a motor including a direct current (DC) motor, a step motor, and a servo motor and may be operated in a protruding or embedded state using a pneumatic or hydraulic method. In this way, the actuators 30 may implement various dynamic movements of one or more of articulation, speech, and facial expression of the robot object's head-and-neck 22.

As illustrated in FIG. 61, since the actuator 30 may be driven by a motor including a DC motor, a step motor, and a servo motor and may be operated using a pneumatic or hydraulic method, the actuator 30 may be tensile and be able to contract or relax.

As illustrated in FIG. 62, the actuator 30 may be disposed at the robot object's head-and-neck 22.

In addition to the methods shown in the drawings, the sensor part 100 may include the followings.

1. Pressure sensor: micro-electromechanical systems (MEMS) sensor, piezoelectric (pressure-voltage) type, piezoresistive (pressure-resistance) type, capacitive type, pressure-sensitive rubber type, force sensing resistor (FSR) type, inner particle changing type, buckling measurement type.

2. Friction sensor: micro hair array type, friction temperature measurement type.

3. Electrostatic sensor: static electricity consumption type, static electricity generation type.

4. Electric resistance sensor: DC resistance measurement type, alternating current (AC) resistance measurement type, MEMS, lateral electrode array type, layered electrode type, field-effect transistor (FET) type (including an organic-FET, a metal-oxide-semiconductor-FET, a piezoelectric-oxide-semiconductor-FET and the like).

5. Tunnel effect tactile sensor: quantum tunnel composite type, electron tunneling type, electroluminescent light type.

6. Heat resistance sensor: heat conductivity measurement type, thermoelectric type.

7. Optical sensor: light intensity measurement type, refractive index measurement type.

8. Magnetism-based sensor: Hall-effect measurement type, magnetic flux measurement type.

9. Ultrasonic-based sensor: acoustic resonance frequency type, surface noise type, ultrasonic emission measurement type

10. Soft material sensor: pressure measurement type, stress measurement type, or strain measurement type and stimuli responsive type using a material such as rubber, a powder, a porous material, sponge, hydrogel, aerogel, a carbon fiber, carbon nanomaterials, carbon nanotubes, graphene, graphite, a composite material, composite nanomaterials, a metal-polymer composite material, a ceramic-polymer composite material, or a conductive polymer.

11. Piezoelectric material sensor: types using a ceramic materials such as quartz and lead zirconate titanate (PZT), a polymer materials such as PVDF, PVDF copolymers, or PVDF-TrFE, or nanomaterials such as cellulose, ZnO, or nanowires.

1. A speech intention expression system comprising:
a sensor part which is adjacent to one surface of a speaker's head and neck and measures physical characteristics of articulators;
a data interpretation part which grasps an articulatory feature of the speaker on the basis of a position of the sensor part and the physical characteristics of the articulators;
a data conversion part which converts the position of the sensor part and the articulatory feature into speech data; and
a data expression part which expresses the speech data to the outside,
wherein the sensor part includes an oral tongue sensor corresponding to an oral tongue.

2. The speech intention expression system of claim 1, wherein the oral tongue sensor is fixed to one side surface of the oral tongue, surrounds a surface of the oral tongue, or is inserted into the oral tongue and grasps a change in vector quantity with time based on x-axis, y-axis, and z-axis directions of the oral tongue according to speech so that at least one physical characteristic among a height, frontness or backness, a degree of curve, a degree of stretch, a degree of rotation, a degree of tension, a degree of contraction, a degree of relaxation, and a degree of vibration of the oral tongue is grasped.

3. The speech intention expression system of claim 1, wherein the oral tongue sensor is fixed to one side surface of the oral tongue, surrounds a surface of the oral tongue, or is inserted into the oral tongue and grasps a change in an angle of rotation per unit time based on x-axis, y-axis, and z-axis directions of the oral tongue according to speech so that physical characteristics of the articulators including the oral tongue are grasped.

4. The speech intention expression system of claim 1, wherein the oral tongue sensor is fixed to one side surface of the oral tongue or surrounds a surface of the oral tongue and grasps the degree of bending of the oral tongue using a piezoelectric element in which an electrical signal corresponding to polarization caused by a change in a crystal structure is generated according to a physical force generated due to contraction and relaxation of the oral tongue according to speech so that at least one physical characteristic among a height, frontness or backness, a degree of curve, a degree of stretch, a degree of rotation, a degree of tension, a degree of contraction, a degree of relaxation, and a degree of vibration of the oral tongue is grasped.

5. The speech intention expression system of claim 1, wherein the sensor part includes a triboelectric element which grasps at least one physical characteristic among a degree of plosion, a degree of friction, a degree of resonance, and a degree of approach of the oral tongue according to a triboelectric generator which corresponds to approach and contact caused by an interaction between the oral tongue and another articulator inside or outside the head and neck.

6. The speech intention expression system of claim 1, wherein the data interpretation part grasps at least one articulatory feature of consonants and vowels, lexical stress, and tonic stress, which are spoken by the speaker, through physical characteristics of the oral tongue and another articulator measured by the sensor part.

7. The speech intention expression system of claim 6, wherein, in grasping the articulatory feature using the physical characteristics of the articulators measured by the sensor part, the data interpretation part measures at least one articulatory feature among a degree of rightness/wrongness of the pronunciation and stress, a degree of similarity/contiguity, and an intention of speech of the speaker on the basis of a standard articulatory feature matrix formed of numerical values including binary numbers or real numbers.

8. The speech intention expression system of claim 7, wherein, in grasping the articulatory features through the physical characteristics of the articulators measured by the sensor part, the data interpretation part grasps the articulatory features according to an operation of recognizing the physical characteristics of the articulators as patterns of consonant and vowel units, an operation of extracting features of the patterns of the consonant and vowel units and classifying the extracted features of the patterns of the consonant and vowel units according to the degree of similarity, an operation of recombining the classified features of the patterns of the consonant and vowel units, and an operation of interpreting the physical characteristics of the articulators as the articulatory features.

9. The speech intention expression system of claim 7, wherein, using the physical characteristics of the articulators measured by the sensor part, the data interpretation part measures at least one articulatory variation, which is a secondary articulation phenomenon, among asperation, syllabic consonant, flapping, tensification, labilalization, velarization, dentalization, palatalization, nasalization, stress shift, and lengthening which are caused by assimilation, dissimilation, elision, attachment, stress, and reduction of the consonants and vowels.

10. The speech intention expression system of claim 1, wherein the oral tongue sensor includes a circuit part for sensor operation, a capsule part which surrounds the circuit part, and an adhesive part attached to one surface of the oral tongue.

11. The speech intention expression system of claim 10, wherein the oral tongue sensor is in a form of a film having a thin film circuit and is operated adjacent to the oral tongue.

12. The speech intention expression system of claim 1, wherein the sensor part includes at least one reference sensor which generates a reference potential for measurement of neural signals of head-and-neck muscles and facial sensors including at least one positive electrode sensor and at least one negative electrode sensor which measure the neural signals of the head-and-neck muscles.

13. The speech intention expression system of claim 12, wherein, in obtaining the position of the sensor part on the basis of the facial sensors, the data interpretation part grasps a potential difference between the at least one positive electrode sensor and the at least one negative electrode sensor on the basis of the reference sensor to grasp positions of the facial sensors.

14. The speech intention expression system of claim 12, wherein, in obtaining the articulatory feature of the speaker on the basis of the facial sensors, the data interpretation part grasps a potential difference between the at least one positive electrode sensor and the at least one negative electrode sensor on the basis of the reference sensor to grasp the articulatory feature due to the physical characteristics of the articulators that occur in the head and neck of the speaker.

15. The speech intention expression system of claim 1, wherein the sensor part includes a vocal cord sensor which is adjacent to vocal cords in the head and neck of the speaker and grasps an electromyogram or trembling of the vocal cords to grasp at least one piece of speech history information among a start of speech, a pause of speech, and an end of speech of the speaker.

16. The speech intention expression system of claim 1, wherein the sensor part includes a teeth sensor which is adjacent to one surface of teeth and grasps a signal generation position according to a change in an electric capacitance which occurs due to contact between the oral tongue and a lower lip.

17. The speech intention expression system of claim 1, wherein the data interpretation part acquires a voice of the speaker according to speech by using a voice acquisition sensor adjacent to one surface of the head and neck of the speaker.

18. The speech intention expression system of claim 1, wherein the sensor part includes an imaging sensor which images the head and neck of the speaker in order to grasp at least one of information on changes in the head and neck articulators of the speaker, information on changes in facial expressions made by the head and neck of the speaker, and nonverbal expressions of the head and neck, chest, arms, and legs which move according to an intention of speech of the speaker.

19. The speech intention expression system of claim 1, further comprising a power supply which supplies power to at least one of the oral tongue sensor, a facial sensor, a voice acquisition sensor, a vocal cord sensor, a teeth sensor, and an imaging sensor of the sensor part.

20. The speech intention expression system of claim 1, further comprising a wired or wireless communication part which, when the data interpretation part and a database part operate while being disposed outside, is linked to and communicates with the data interpretation part and the database part.

21. The speech intention expression system of claim 1, wherein the data interpretation part is linked to the database part which includes at least one speech data index corresponding to the position of the sensor part, the articulatory features of the speaker, and a voice of the speaker.

22. The speech intention expression system of claim 21, wherein, on the basis of at least one piece of information among a time duration of speech, a frequency according to the speech, an amplitude of the speech, an electromyogram of head-and-neck muscles according to the speech, a change in positions of the head-and-neck muscles according to the speech, and a change in a position of the oral tongue due to bending and rotation, the database part forms at least one speech data index among a consonant-and-vowel phoneme unit index, a syllable unit index, a word unit index, a phrase unit index, a sentence unit index, a consecutive speech unit index, and a pronunciation height index.

23. The speech intention expression system of claim 1, wherein the data expression part is linked to a speech data index of the database part and shows the articulatory features of the speaker as at least one speech expression among a consonant-and-vowel phoneme unit, at least one word unit, at least one phrase unit (citation forms), at least one sentence unit, and a consecutive speech unit.

24. The speech intention expression system of claim 23, wherein the speech expression shown by the data expression part is visualized to at least one of an alphabet, a figure, a special symbol, and a number or auralized in a form of a sound to be provided to the speaker and a listener.

25. The speech intention expression system of claim 23, wherein the speech expression shown by the data expression part is provided to the speaker and a listener by using at least one tactile method among vibrating, snoozing, tapping, pressing, and relaxing.

26. The speech intention expression system of claim 1, wherein the data conversion part converts the position of the sensor part and information on changes in facial expressions made by the head and neck into first base data and converts the articulatory feature, information on changes in the articulators, and the information on the changes in the facial expressions made by the head and neck into second base data to generate object head-and-neck data required for at least one object of an image object's head and neck and a robot object's head and neck.

27. The speech intention expression system of claim 26, further comprising a data matching part which, in expressing the object head-and-neck data processed by the data interpretation part to the image object's head and neck or the robot object's head and neck, sets static basic coordinates on the basis of the first base data of the data conversion part and sets dynamic variable coordinates on the basis of the second base data to generate a matching position.

28. The speech intention expression system of claim 27, wherein the object head-and-neck data is transmitted to an actuator disposed at one surface of the robot object's head and neck by the data matching part, and the actuator implements movement of the robot object's head and neck, including at least one of articulation, speech, and facial expressions, according to the object head-and-neck data.
